(19) United States
(12) Patent Application Publication
(10) Pub. No.: US 2026/0166877 A1
(43) Pub. Date: Jun. 18, 2026

(54) LIQUID EJECTION APPARATUS, HEAD UNIT, AND INSPECTION METHOD OF LIQUID EJECTION APPARATUS

(71) Applicant: SEIKO EPSON CORPORATION, Tokyo (JP)

(72) Inventor: Daichi ORIHARA, Shiojiri (JP)

(21) Appl. No.: 19/419,198

(22) Filed: Dec. 15, 2025

(30) Foreign Application Priority Data
Dec. 16, 2024 (JP) 2024-220100

(51) Int. Cl. B41J 2/045

(52) U.S. Cl. CPC B41J 2/0457; B41J 2/0451; B41J 2/04541; B41J 2/0455; B41J 2/04581; B41J 2/04588

(57) ABSTRACT

Provided is a liquid ejection apparatus including: an ejection portion that includes a piezoelectric element driven by a drive signal, a detection portion that detects a potential of the piezoelectric element, an inspection portion that inspects the ejection portion based on a detection result of the detection portion, a third switch that switches presence and absence of an electrical coupling between a first wiring and a second wiring, and a designation portion that designates an electrical coupling state of the third switch, in which the designation portion executes a charging operation in which the third switch enters an ON state in a part of a preparation period before inspection of the ejection portion by the inspection portion, and terminates the charging operation when a potential signal corresponding to a potential detected by the detection portion satisfies a specific condition.

The present application is based on, and claims priority from JP Application Serial Number 2024-220100, filed Dec. 16, 2024, the disclosure of which is hereby incorporated by reference herein in its entirety.

### BACKGROUND

### 1. Technical Field

The present disclosure relates to a liquid ejection apparatus, a head unit, and an inspection method of the liquid ejection apparatus.

### 2. Related Art

Liquid ejection apparatuses including an ejection portion that ejects a liquid and a piezoelectric element driven by a drive signal, such as an ink jet printer, are widely used. For example, JP-A-2022-098988 discloses a liquid ejection apparatus including a piezoelectric element that includes a drive electrode and is driven by a drive signal supplied to the drive electrode via a first wiring, a detection portion that detects a potential of the drive electrode via a second wiring, an inspection portion that inspects an ejection portion based on a detection result of the detection portion, a first switch that switches whether or not to electrically couple the first wiring and the drive electrode, and a second switch that switches whether or not to electrically couple the second wiring and the drive electrode. In JP-A-2022-098988, in order to suppress a decrease in inspection accuracy of the ejection portion by the inspection portion due to capacitance that is parasitic on the second switch, there is proposed a technique related to a charging operation of charging the capacitance that is parasitic on the second switch via the first switch and the second switch by the drive signal supplied to the first wiring before inspection of the ejection portion by the inspection portion.

However, according to the related art, there is a possibility that the charging operation for charging the parasitic capacitance on the second switch may cause overcharging or insufficient charging.

### SUMMARY

To solve the above problems, according to an aspect of the present disclosure, there is provided a liquid ejection apparatus including: an ejection portion that includes a piezoelectric element driven by a drive signal supplied to a drive electrode via a first wiring and ejects a liquid in correspondence with the drive of the piezoelectric element; a detection portion that detects a potential of the drive electrode via a second wiring; an inspection portion that inspects the ejection portion based on a detection result of the detection portion; a first switch that switches whether or not to electrically couple the first wiring and the drive electrode; a second switch that switches whether or not to electrically couple the second wiring and the drive electrode; a third switch that switches whether or not to electrically couple the first wiring and the second wiring; and a designation portion that designates an electrical coupling state of the third switch, in which the designation portion executes a first charging operation in which the third switch enters an ON state in at least one period of a preparation period before inspection of the ejection portion by the inspection portion, terminates the first charging operation when a potential signal corresponding to a potential detected by the detection portion satisfies a specific condition, and continues the first charging operation when the potential signal does not satisfy the specific condition.

In addition, according to another aspect of the present disclosure, there is provided a head unit including: an ejection portion that includes a piezoelectric element driven by a drive signal supplied to a drive electrode via a first wiring and ejects a liquid in correspondence with the drive of the piezoelectric element; a detection portion that detects a potential of the drive electrode via a second wiring, and supplies a result signal indicating a detection result to an inspection portion that inspects the ejection portion based on the result signal; a first switch that switches whether or not to electrically couple the first wiring and the drive electrode; a second switch that switches whether or not to electrically couple the second wiring and the drive electrode; a third switch that switches whether or not to electrically couple the first wiring and the second wiring; and a designation portion that designates an electrical coupling state of the third switch, in which the designation portion executes a first charging operation in which the third switch enters an ON state in at least one period of a preparation period before inspection of the ejection portion by the inspection portion, terminates the first charging operation when a potential signal corresponding to a potential detected by the detection portion satisfies a specific condition, and continues the first charging operation when the potential signal does not satisfy the specific condition.

Further, according to still another aspect of the present disclosure, there is provided an inspection method of a liquid ejection apparatus including an ejection portion that includes a piezoelectric element driven by a drive signal supplied to a drive electrode via a first wiring and ejects a liquid in correspondence with the drive of the piezoelectric element, a detection portion that detects a potential of the drive electrode via a second wiring, an inspection portion that inspects the ejection portion based on a detection result of the detection portion, a first switch that switches whether or not to electrically couple the first wiring and the drive electrode, a second switch that switches whether or not to electrically couple the second wiring and the drive electrode, and a third switch that switches whether or not to electrically couple the first wiring and the second wiring, the method including: executing a first charging operation in which the third switch enters an ON state in at least one period of a preparation period before inspection of the ejection portion by the inspection portion; and terminating the first charging operation when a potential signal corresponding to a potential detected by the detection portion satisfies a specific condition, and continuing the first charging operation when the potential signal does not satisfy the specific condition.

### BRIEF DESCRIPTION OF THE DRAWINGS

FIG. 1 is a block diagram illustrating an example of a configuration of an ink jet printer according to an embodiment of the present disclosure.

FIG. 2 is a perspective view illustrating an example of a schematic internal structure of the ink jet printer.

FIG. 3 is a sectional view for explaining an example of a structure of an ejection portion.

FIG. 4 is a plan view illustrating an example of an arrangement of nozzles in the ink jet printer.

FIG. 5 is a block diagram illustrating an example of a configuration of a head unit.

FIG. 6 is a block diagram illustrating an example of a configuration of a detection circuit.

FIG. 7 is a timing chart for explaining an example of a signal supplied to the head unit.

FIG. 8 is an explanatory view for explaining an example of an operation of a coupling state designation circuit.

FIG. 9 is an explanatory view for explaining an example of the operation of the coupling state designation circuit.

FIG. 10 is a timing chart for explaining an example of a signal supplied to the head unit.

FIG. 11 is an explanatory view for explaining an example of the operation of the coupling state designation circuit.

FIG. 12 is an explanatory view for explaining an example of the operation of the coupling state designation circuit.

FIG. 13 is a flowchart illustrating an example of an operation of an ink jet printer when a non-print process is executed.

FIG. 14 is an explanatory view for explaining an example of a detection potential signal.

FIG. 15 is an explanatory view illustrating an example of an operation of the head unit when a low-speed charging process is executed.

FIG. 16 is a block diagram illustrating an example of the operation of the head unit in the low-speed charging process.

FIG. 17 is a block diagram illustrating an example of the operation of the head unit in the low-speed charging process.

FIG. 18 is a block diagram illustrating an example of the operation of the head unit in the low-speed charging process.

FIG. 19 is a block diagram illustrating an example of the operation of the head unit in the low-speed charging process.

FIG. 20 is a block diagram illustrating an example of the operation of the head unit in the low-speed charging process.

FIG. 21 is an explanatory view illustrating an example of an operation of the head unit when a high-speed charging process is executed.

FIG. 22 is a block diagram illustrating an example of the operation of the head unit in the high-speed charging process.

FIG. 23 is a block diagram illustrating an example of the operation of the head unit in the high-speed charging process.

FIG. 24 is a block diagram illustrating an example of the operation of the head unit in the high-speed charging process.

FIG. 25 is a block diagram illustrating an example of the operation of the head unit in the high-speed charging process.

FIG. 26 is a block diagram illustrating an example of the operation of the head unit in the high-speed charging process.

FIG. 27 is an explanatory view illustrating an example of an operation of the head unit when an inspection process is executed.

FIG. 28 is a block diagram illustrating an example of the operation of the head unit in the inspection process.

FIG. 29 is a block diagram illustrating an example of the operation of the head unit in the inspection process.

FIG. 30 is a block diagram illustrating an example of the operation of the head unit in the inspection process.

FIG. 31 is a block diagram illustrating an example of the operation of the head unit in the inspection process.

FIG. 32 is a block diagram illustrating an example of the operation of the head unit in the inspection process.

FIG. 33 is an explanatory view for explaining an example of an operation of an inspection unit.

FIG. 34 is an explanatory view for explaining an example of a detection potential signal according to Modification Example 1 of the present disclosure.

FIG. 35 is a flowchart illustrating an example of an operation of the ink jet printer when a non-print process according to Modification Example 2 of the present disclosure is performed.

### DESCRIPTION OF EMBODIMENTS

Hereinafter, embodiments for carrying out the present disclosure will be described with reference to the drawings. Meanwhile, a dimension and a scale of each portion are different from actual ones as appropriate in each drawing. The embodiments described below are preferred specific examples of the present disclosure and are thus added with technically preferred various limitations, but the scope of the present disclosure is not limited to such embodiments unless description for limiting the present disclosure is made in the following description.

### A. Embodiment

In the present embodiment, a liquid ejection apparatus will be described by exemplifying an ink jet printer 1 that forms an image on recording paper PP by ejecting ink.

### 1. Overview of Ink Jet Printer

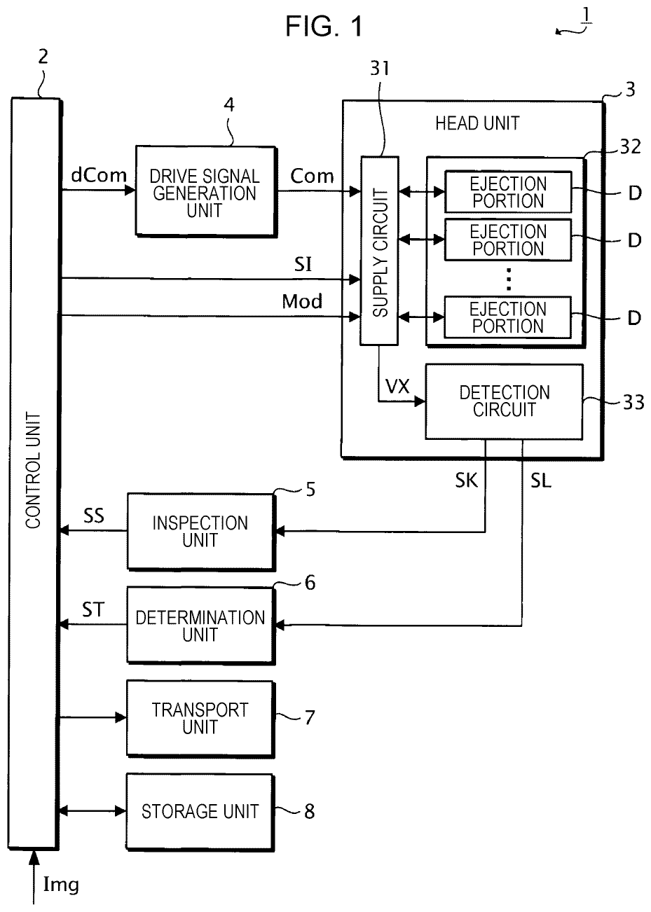

Hereinafter, an example of a configuration of the ink jet printer 1 according to the present embodiment will be described with reference to FIGS. 1 to 4.

FIG. 1 is a functional block diagram illustrating an example of the configuration of the ink jet printer 1.

As illustrated in FIG. 1, the ink jet printer 1 is supplied with print data Img indicating an image to be formed by the ink jet printer 1 from a host computer such as a personal computer or a digital camera. The ink jet printer 1 executes a print process of forming an image, which is indicated by the print data Img supplied from the host computer, on the recording paper PP.

As illustrated in FIG. 1, the ink jet printer 1 includes a control unit 2 that controls each portion of the ink jet printer 1, a head unit 3 provided with an ejection portion D that ejects ink, a drive signal generation unit 4 that generates a drive signal Com for driving the ejection portion D, an inspection unit 5 that inspects the ejection portion D, a determination unit 6 that determines termination of the charging process performed before the inspection of the ejection portion D, a transport unit 7 that changes a relative position of the recording paper PP with respect to the head unit 3, and a storage unit 8 that stores various pieces of information.

Note that the ink jet printer 1 is an example of a “liquid ejection apparatus”, the ink is an example of a “liquid”, the inspection unit 5 is an example of an “inspection portion”, the determination unit 6 is an example of a “determination portion”, and the storage unit 8 is an example of a “storage device”.

In the present embodiment, it is assumed that the ink jet printer 1 includes one or a plurality of head units 3, one or a plurality of drive signal generation units 4 corresponding to one or a plurality of head units 3 on a one-to-one basis, one or a plurality of inspection units 5 corresponding to one or a plurality of head units 3 on a one-to-one basis, and one or a plurality of determination units 6 corresponding to one or a plurality of head units 3 on a one-to-one basis. Specifically, in the present embodiment, it is assumed that the ink jet printer 1 includes four head units 3, four drive signal generation units 4 that correspond to the four head units 3 on a one-to-one basis, four inspection units 5 that correspond to the four head units 3 on a one-to-one basis, and four determination units 6 that correspond to the four head units 3 on a one-to-one basis. However, in the following description, for convenience of description, as illustrated in FIG. 1, one head unit 3 among the four head units 3, one drive signal generation unit 4 provided in correspondence with the one head unit 3 among the four drive signal generation units 4, one inspection unit 5 provided in correspondence with the one head unit 3 among the four inspection units 5, and one determination unit 6 provided in correspondence with the one head unit 3 among the four determination units 6 are focused on and described.

The storage unit 8 is configured to include one or both of a volatile memory such as a random access memory (RAM) and a non-volatile memory such as a read only memory (ROM), an electrically erasable programmable read-only memory (EEPROM), or a programmable ROM (PROM), and stores a control program of the ink jet printer 1.

The control unit 2 includes one or a plurality of central processing units (CPU). However, the control unit 2 may be provided with a programmable logic device such as a field-programmable gate array (FPGA) instead of the CPU or in addition to the CPU. The control unit 2 executes a control program stored in the storage unit 8 and controls each portion of the ink jet printer 1 in accordance with the control program.

Specifically, the control unit 2 generates a waveform designation signal dCom and supplies the generated waveform designation signal dCom to the drive signal generation unit 4. The waveform designation signal dCom is a digital signal that defines a waveform of a drive signal Com. The drive signal Com is an analog signal for driving the ejection portion D. The drive signal generation unit 4 includes a DA conversion circuit and generates the drive signal Com having a waveform defined by the waveform designation signal dCom.

Further, the control unit 2 generates a designation signal SI and supplies the generated designation signal SI to the head unit 3. The designation signal SI is a digital signal designating a type of an operation of the ejection portion D. Specifically, the designation signal SI is a signal that designates the type of the operation of the ejection portion D by designating whether or not it is driven by supplying the drive signal Com to the ejection portion D.

When a print process is executed, the control unit 2 generates a signal for controlling the head unit 3 such as the designation signal SI based on the print data Img. In addition, when the print process is executed, the control unit 2 generates a signal for controlling the drive signal generation unit 4 such as the waveform designation signal dCom. In addition, when the print process is executed, the control unit 2 generates a signal for controlling the transport unit 7. As a result, in the print process, the control unit 2 controls the transport unit 7 to change a relative position of the recording paper PP with respect to the head unit 3, adjusts the presence/absence of ink ejection from the ejection portion Dm, an ejection amount of ink, an ejection timing of ink, and the like, and controls each portion of the ink jet printer 1 to form an image corresponding to the print data Img on the recording paper PP.

The control unit 2 generates a mode signal Mod and supplies the generated mode signal Mod to the head unit 3. The mode signal Mod is a signal indicating a value corresponding to a process executed by the ink jet printer 1. In the present embodiment, as an example, it is assumed that the mode signal Mod is set to a value “1” indicating that the ink jet printer 1 is executing the print process when the ink jet printer 1 is executing the print process, and is set to a value “0” indicating that the ink jet printer 1 is executing a process other than the print process when the ink jet printer 1 is executing a process other than the print process. Note that in the present embodiment, the process other than the print process includes the charging process described above and an inspection process described later. Hereinafter, a process other than the print process, which includes the charging process and the inspection process, may be referred to as a non-print process.

As illustrated in FIG. 1, the head unit 3 includes a supply circuit 31, a recording head 32, and a detection circuit 33.

The recording head 32 includes M ejection portions D. In this case, the value M is a natural number that satisfies “M≥2”. Note that hereinafter, among the M ejection portions D provided in the recording head 32, an m-th ejection portion D may be referred to as an ejection portion D[m]. In this case, the variable m is a natural number that satisfies “1≤m≤M”. In addition, in the following description, when a component, a signal, or the like of the ink jet printer 1 corresponds to the ejection portion D[m] among the M ejection portions D, a subscript [m] may be added to a code for representing the component, signal, or the like.

The supply circuit 31 switches whether or not to supply the drive signal Com to the ejection portion D[m] based on the designation signal SI. In the following description, among a plurality of the drive signals Com, a drive signal Com supplied to the ejection portion D[m] may be referred to as a supply drive signal Vin[m].

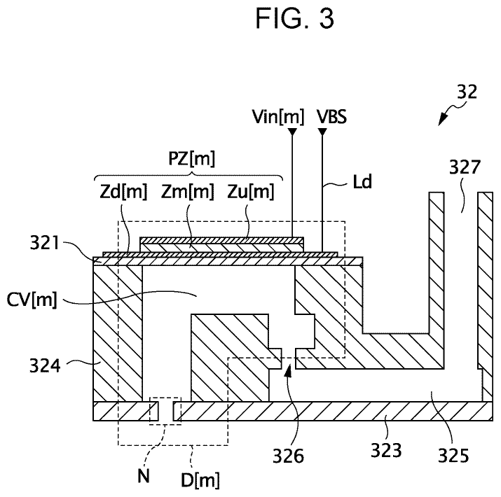

Further, the supply circuit 31 switches whether or not to supply an electrode potential signal VX[m] to the detection circuit 33 based on the designation signal SI. Here, the electrode potential signal VX[m] is a signal indicating a potential of an upper electrode Zu[m] provided in a piezoelectric element PZ[m] included in the ejection portion D[m]. Note that the piezoelectric element PZ[m] and the upper electrode Zu[m] will be described later with reference to FIG. 3.

The detection circuit 33 generates a detection result signal SK[m] based on the electrode potential signal VX[m] supplied from the ejection portion D[m] via the supply circuit 31. Here, the detection result signal SK[m] is a signal indicating a potential corresponding to a potential of the electrode potential signal VX[m]. More specifically, in the present embodiment, the detection result signal SK[m] is a signal obtained by amplifying the electrode potential signal VX[m] and removing a noise component from the amplified electrode potential signal VX[m].

In addition, the detection circuit 33 generates a detection potential signal SL. Here, the detection potential signal SL is a signal indicating a potential corresponding to a potential detection result by the detection circuit 33.

Note that the detection circuit 33 is an example of a “detection portion”, the detection result signal SK[m] is an example of a “result signal”, and the detection potential signal SL is an example of a “potential signal”.

The inspection unit 5 inspects the ejection portion D[m] based on the detection result signal SK[m] supplied from the detection circuit 33, and outputs an inspection result signal SS[m] indicating a result of the inspection. Hereinafter, the ejection portion D[m] to be inspected by the inspection unit 5 may be referred to as an inspection target ejection portion DK.

The ink jet printer 1 executes an inspection process, which is a series of processes including an inspection of the inspection target ejection portion DK by the inspection unit 5 and driving of the inspection target ejection portion DK for executing the inspection of the inspection target ejection portion DK.

When the inspection process is executed, the control unit 2 supplies the designation signal SI to the head unit 3. As a result, the control unit 2 designates the inspection target ejection portion DK among the ejection portions D[1] to D[M]. The control unit 2 controls the head unit 3 such that the inspection target ejection portion DK is driven by the drive signal Com and the electrode potential signal VX[m] detected from the inspection target ejection portion DK is supplied to the detection circuit 33. Further, when the inspection process is executed, the detection circuit 33 generates the detection result signal SK[m] based on the electrode potential signal VX[m] detected from the inspection target ejection portion DK. Then, when the inspection process is executed, the inspection unit 5 inspects the ejection portion D[m] driven as the inspection target ejection portion DK based on the detection result signal SK[m] supplied from the detection circuit 33, and outputs the inspection result signal SS[m] indicating the inspection result.

In the present embodiment, as described above, the charging process for charging a parasitic capacitance that is parasitic on a supply path of the electrode potential signal VX[m] in the supply circuit 31 is performed before the inspection process including the inspection of the ejection portion D[m] by the inspection unit 5.

The determination unit 6 determines termination of the charging process based on the detection potential signal SL supplied from the detection circuit 33, and outputs a charging termination designation signal ST indicating a result of the determination. In the following description, the ejection portion D[m] used as a charging path of the parasitic capacitance in the charging process may be referred to as a charging path ejection portion DC.

Note that in the present embodiment, it is assumed that the ink jet printer 1 can perform a charging process according to a low-speed charging mode and a charging process according to a high-speed charging mode as the charging process. Hereinafter, the charging process according to the low-speed charging mode will be referred to as a low-speed charging process, and the charging process according to the high-speed charging mode will be referred to as a high-speed charging process. Here, the high-speed charging process is a process of charging the parasitic capacitance at a higher speed as compared with the low-speed charging process. The ink jet printer 1 can selectively execute one charging process of the low-speed charging process or the high-speed charging process as the charging process.

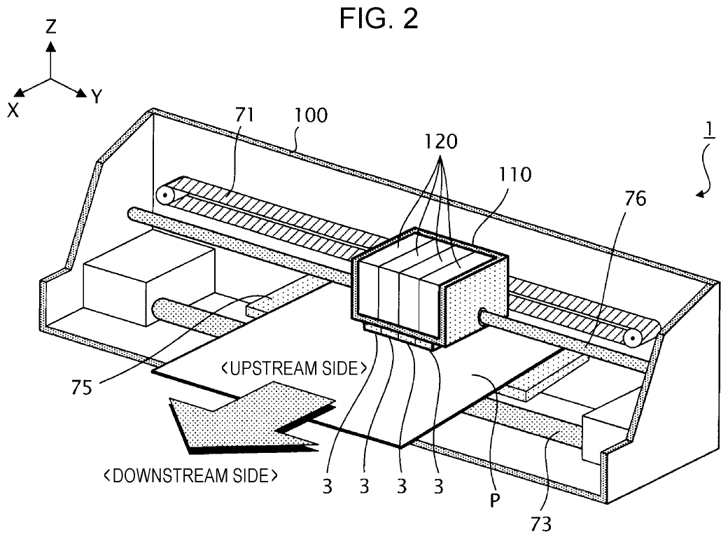

FIG. 2 is a perspective view illustrating an example of a schematic internal structure of the ink jet printer 1.

As illustrated in FIG. 2, in the present embodiment, it is assumed that the ink jet printer 1 is a serial printer. Specifically, when executing the print process, the ink jet printer 1 ejects ink from the ejection portion D[m] while transporting the recording paper PP in an X1 direction and reciprocating the head unit 3 in a Y1 direction intersecting the X1 direction and a Y2 direction opposite to the Y1 direction, thereby forming dots corresponding to the print data Img on the recording paper PP.

In the following description, the X1 direction and an X2 direction opposite to the X1 direction are collectively referred to as an “X-axis direction”, the Y1 direction intersecting the X-axis direction and the Y2direction opposite to the Y1 direction are collectively referred to as a “Y-axis direction”, and a Z1 direction intersecting the X-axis direction and the Y-axis direction and a Z2 direction opposite to the Z1 direction are collectively referred to as a “Z-axis direction”. In the present embodiment, as an example, a description will be made by assuming that the X-axis direction, the Y-axis direction, and the Z-axis direction are orthogonal to each other. Meanwhile, the present disclosure is not limited to such an aspect. The X-axis direction, the Y-axis direction, and the Z-axis direction may intersect each other. Note that in the present embodiment, the Z1 direction is a direction in which the ink is ejected from the ejection portion D[m].

As illustrated in FIG. 2, the ink jet printer 1 according to the present embodiment includes a housing 100 and a carriage 110 configured to reciprocate in the Y-axis direction in the housing 100 and including four head units 3 mounted thereon.

In the present embodiment, as illustrated in FIG. 2, it is assumed that the carriage 110 stores four ink cartridges 120 corresponding to four color inks of cyan, magenta, yellow, and black in a one-to-one basis. Further, in the present embodiment, as described above, it is assumed that the ink jet printer 1 includes four head units 3 corresponding to the four ink cartridges 120 on a one-to-one basis. Each ejection portion D[m] receives the ink supplied from the ink cartridge 120 corresponding to the head unit 3 provided with the ejection portion D[m]. As a result, each ejection portion D[m] can fill the inside with the supplied ink and eject the ink filled inside the ejection portion D[m] from a nozzle N provided in the ejection portion D[m]. Note that the ink cartridge 120 may be provided outside the carriage 110.

Further, as described above, the ink jet printer 1 according to the present embodiment includes the transport unit 7. As illustrated in FIG. 2, the transport unit 7 includes a carriage transport mechanism 71 for reciprocating the carriage 110 in the Y-axis direction, a carriage guide shaft 76 for supporting the carriage 110 to reciprocate in the Y-axis direction, a medium transport mechanism 73 for transporting the recording paper PP, and a platen 75 provided in the Z1 direction of the carriage 110. Therefore, when executing the print process, the transport unit 7 reciprocates the head unit 3 in the Y-axis direction along the carriage guide shaft 76 in combination with the carriage 110 by the carriage transport mechanism 71 to transport the recording paper PP on the platen 75 in the X1 direction by the medium transport mechanism 73, so that a relative position of the recording paper PP with respect to the head unit 3 is changed, and the ink can land on the entire recording paper PP.

FIG. 3 is a schematic partial cross-sectional view of the recording head 32 in which the recording head 32 is cut so as to include the ejection portion D[m].

As illustrated in FIG. 3, the ejection portion D[m] is provided with the piezoelectric element PZ[m], a cavity CV[m] filled with the ink, a nozzle N that communicates with the cavity CV[m], and a vibrating plate 321. The ejection portion D[m] ejects the ink in the cavity CV[m] from the nozzle N by driving the piezoelectric element PZ[m] by the supply drive signal Vin[m]. The cavity CV[m] is a space partitioned by a cavity plate 324, a nozzle plate 323 in which the nozzles N are formed, and the vibrating plate 321. The cavity CV[m] communicates with a reservoir 325 via an ink supply port 326. The reservoir 325 communicates with the ink cartridge 120 corresponding to the ejection portion D[m] via a common liquid chamber 327. The piezoelectric element PZ[m] includes the upper electrode Zu[m], a lower electrode Zd[m], and a piezoelectric body Zm[m] provided between the upper electrode Zu[m] and the lower electrode Zd[m]. The lower electrode Zd[m] is electrically coupled to a power supply line Ld set to a predetermined potential VBS. When the supply drive signal Vin[m] is supplied to the upper electrode Zu[m] and a voltage is applied between the upper electrode Zu[m] and the lower electrode Zd[m], the piezoelectric element PZ[m] is displaced in the Z1 direction or the Z2 direction in correspondence with the applied voltage, and as a result, the piezoelectric element PZ[m] vibrates. The lower electrode Zd[m] is joined to the vibrating plate 321. Therefore, when the piezoelectric element PZ[m] is driven by the supply drive signal Vin[m] and vibrates, the vibrating plate 321 also vibrates. The vibration of the vibrating plate 321 changes a volume of the cavity CV[m] and a pressure in the cavity CV[m], and the ink that fills the cavity CV[m] is ejected from the nozzle N.

Note that in the present embodiment, the upper electrode Zu[m] is an example of a “drive electrode”.

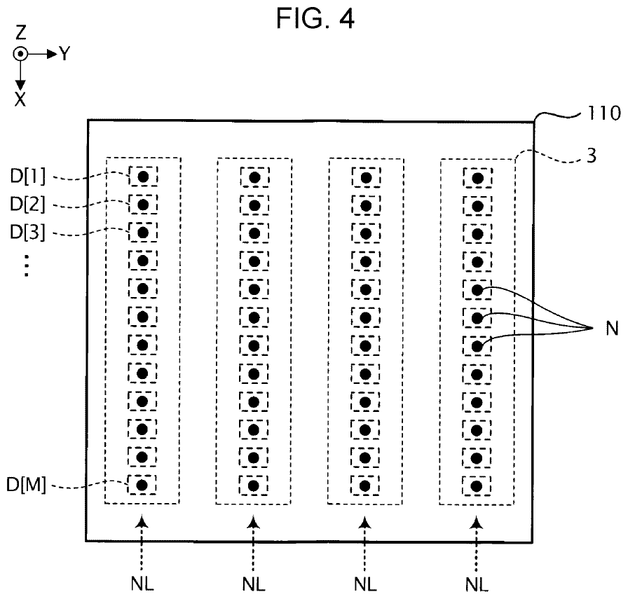

FIG. 4 is an explanatory view for explaining an example of an arrangement of the four head units 3 included in the ink jet printer 1 and a total of 4M nozzles N provided in the four head units 3 when the ink jet printer 1 is viewed in a plan view in the Z2 direction. As illustrated in FIG. 4, each of the head units 3 is provided with a nozzle array Ln. Here, the nozzle array Ln is a plurality of nozzles N provided to extend in a row in a predetermined direction. In the present embodiment, as an example, it is assumed that each nozzle array Ln is constituted by M nozzles N arranged to extend in the X-axis direction.

### 2. Configuration of Head Unit 3

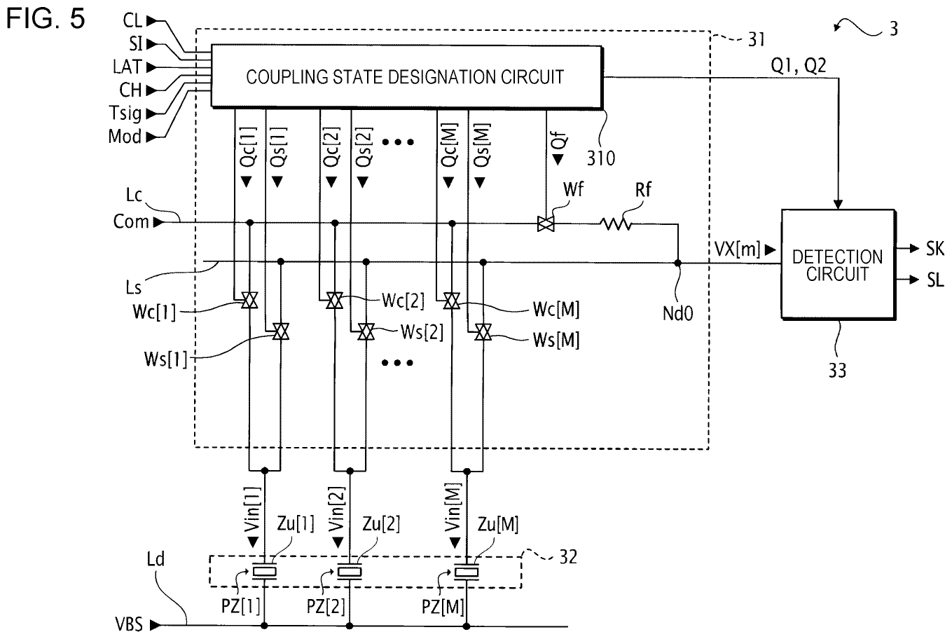

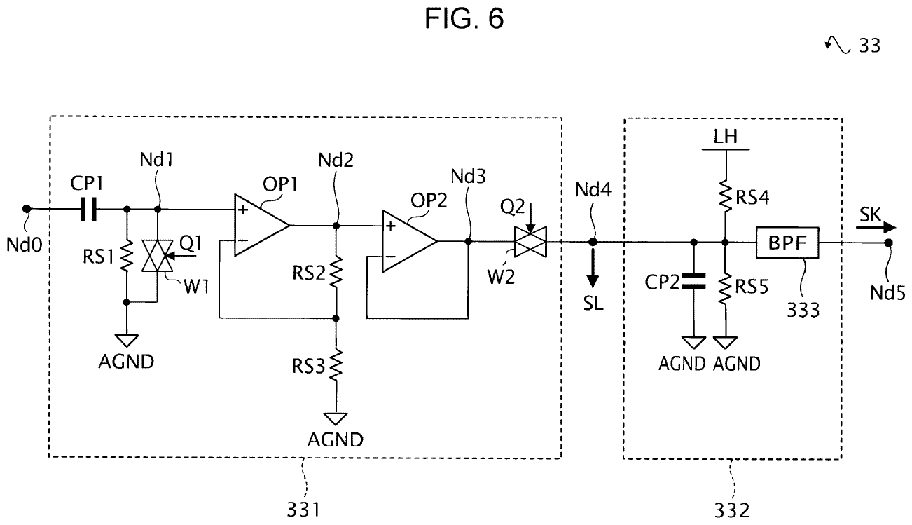

Hereinafter, a configuration of the head unit 3 will be described with reference to FIGS. 5 and 6.

FIG. 5 is a block diagram illustrating an example of the configuration of the head unit 3.

As illustrated in FIG. 5, the head unit 3 includes the supply circuit 31, the recording head 32, and the detection circuit 33. In addition, the head unit 3 includes a wiring Lc through which the drive signal Com is supplied from the drive signal generation unit 4, a power supply line Ld set to the potential VBS, and a wiring Ls for supplying the electrode potential signal VX[m] to the detection circuit 33.

Note that the wiring Lc is an example of a “first wiring”, and the wiring Ls is an example of a “second wiring”.

The supply circuit 31 includes M ejection portions D[1] to D[M] that correspond to M switches Wc[1] to Wc[M] in a one-to-one basis, M switches Ws[1] to Ws[M] that correspond to the M ejection portions D[1] to D[M] in a one-to-one basis, a switch Wf, a resistor Rf, and a coupling state designation circuit 310 that designates a coupling state of each switch.

The coupling state designation circuit 310 generates a coupling state designation signal Qc[m] that designates ON/OFF of the switch Wc[m], a coupling state designation signal Qs[m] that designates ON/OFF of the switch Ws[m], a coupling state designation signal Qf that designates ON/OFF of the switch Wf, a coupling state designation signal Q1 that designates ON/OFF of a switch W1 to be described later, and a coupling state designation signal Q2 that designates ON/OFF of a switch W2 to be described later based on at least some of the designation signal SI, a latch signal LAT, a change signal CH, a period designation signal Tsig, the mode signal Mod, and a clock signal CL supplied from the control unit 2.

The switch Wc[m] switches conduction and non-conduction between the wiring Lc and the upper electrode Zu[m] of the piezoelectric element PZ[m] based on the coupling state designation signal Qc[m]. In the present embodiment, the switch Wc[m] is turned on when the coupling state designation signal Qc[m] is at a high level, and is turned off when the coupling state designation signal Qc[m] is at a low level. When the switch Wc[m] is turned on, the drive signal Com supplied to the wiring Lc is supplied to the upper electrode Zu[m] of the ejection portion D[m] as the supply drive signal Vin[m].

The switch Ws[m] switches conduction and non-conduction between the wiring Ls and the upper electrode Zu[m] of the piezoelectric element PZ[m] based on the coupling state designation signal Qs[m]. In the present embodiment, the switch Ws[m] is turned on when the coupling state designation signal Qs[m] is at a high level, and is turned off when the coupling state designation signal Qs[m] is at a low level. When the switch Ws[m] is turned on, a potential of the upper electrode Zu[m] provided in the ejection portion D[m] is supplied to the detection circuit 33 via the wiring Ls as the electrode potential signal VX[m].

The switch Wf switches conduction and non-conduction between the wiring Lc and the wiring Ls based on the coupling state designation signal Qf. In the present embodiment, the switch Wf is turned on when the coupling state designation signal Qf is at a high level, and is turned off when the coupling state designation signal Qf is at a low level. When the switch Wf is turned on, the drive signal Com supplied to the wiring Lc is supplied to a node Nd0, which is a part of the wiring Ls, via the resistor Rf electrically coupled between the switch Wf and the wiring Ls.

The resistor Rf is provided between the switch Wf and the wiring Ls. However, the resistor Rf may be provided between the wiring Lc and the switch Wf.

Note that in the present embodiment, the coupling state designation circuit 310 is an example of a “designation portion”, the switch Wc[m] is an example of a “first switch”, the switch Ws[m] is an example of a “second switch”, the switch Wf is an example of a “third switch”, and the resistor Rf is an example of a “resistive element”.

In the present embodiment, the detection circuit 33 generates a detection result signal SK[m] having a waveform corresponding to a waveform of the electrode potential signal VX[m] based on the electrode potential signal VX[m] supplied from the wiring Ls. Specifically, the detection circuit 33 generates a signal obtained by amplifying the electrode potential signal VX[m] and removing a noise component from the electrode potential signal VX[m], and outputs the generated signal as the detection result signal SK[m]. In addition, the detection circuit 33 generates the detection potential signal SL based on a potential of the wiring Ls which is detected by the detection circuit 33.

FIG. 6 is a block diagram illustrating an example of a configuration of the detection circuit 33.

As illustrated in FIG. 6, the detection circuit 33 includes a front-stage detection circuit 331 and a rear-stage detection circuit 332. The front-stage detection circuit 331 includes a capacitor CP1, operational amplifiers OP1 to OP2, switches W1 to W2, and resistors RS1 to RS3. The rear-stage detection circuit 332 includes a capacitor CP2, resistors RS4 to RS5, and a band-pass filter 333.

One electrode of the capacitor CP1 is electrically coupled to the node Nd0 and the other electrode is coupled to a node Nd1.

One end of the resistor RS1 is electrically coupled to the node Nd1, and the other end is electrically coupled to an analog ground AGND set to a fixed potential.

The switch W1 switches conduction and non-conduction between the one end of the resistor RS1 and the analog ground AGND. In the present embodiment, the switch W1 is turned on when the coupling state designation signal Q1 is at a high level, and is turned off when the coupling state designation signal Q1 is at a low level.

In the present embodiment, the capacitor CP1, the resistor RS1, and the switch W1 function as a high-pass filter.

The operational amplifier OP1 includes a non-inversion input terminal electrically coupled to the node Nd1, an output terminal electrically coupled to a node Nd2, and an inversion input terminal electrically coupled to the node Nd2 via the resistor RS2 and electrically coupled to the analog ground AGND via the resistor RS3.

In the present embodiment, the operational amplifier OP1, the resistor RS2, and the resistor RS3 function as an amplification circuit that amplifies an amplitude of a signal input to the node Nd1 and outputs the signal to the node Nd2.

The operational amplifier OP2 includes a non-inversion input terminal electrically coupled to the node Nd2, an inversion input terminal electrically coupled to a node Nd3, and an output terminal electrically coupled to the node Nd3.

In the present embodiment, the operational amplifier OP2 functions as a buffer that converts impedance and outputs a low-impedance signal to the node Nd3.

The switch W2 switches conduction and non-conduction between the node Nd3 and a node Nd4. In the present embodiment, the switch W2 is turned on when the coupling state designation signal Q2 is at a high level, and is turned off when the coupling state designation signal Q2 is at a low level. Note that in the present embodiment, the detection circuit 33 outputs a signal supplied from the switch W2 to the node Nd4 as the detection potential signal SL.

One electrode of the capacitor CP2 is electrically coupled to the node Nd4 and the other electrode is electrically coupled to the analog ground AGND.

One end of the resistor RS4 is electrically coupled to the node Nd4, and the other end is electrically coupled to a power supply line LH set to a fixed potential. Specifically, the potential of the power supply line LH may be, for example, a high-potential side power supply potential supplied to the head unit 3.

One end of the resistor RS5 is electrically coupled to the node Nd4, and the other end is electrically coupled to the analog ground AGND.

The band-pass filter 333 outputs the detection result signal SK[m], which is a signal obtained by extracting a specific frequency component from a signal input to the node Nd4, to a node Nd5. Note that the node Nd5 is electrically coupled to the inspection unit 5.

As described above, the detection circuit 33 generates the detection result signal SK[m] based on the electrode potential signal VX[m] input to the node Nd0 and outputs the generated detection result signal SK[m] from the node Nd5. In addition, the detection circuit 33 generates the detection potential signal SL based on the potential of the node Nd0, that is, the potential of the wiring Ls, and outputs the generated detection potential signal SL from the node Nd4.

### 3. Overview of Operation of Head Unit 3

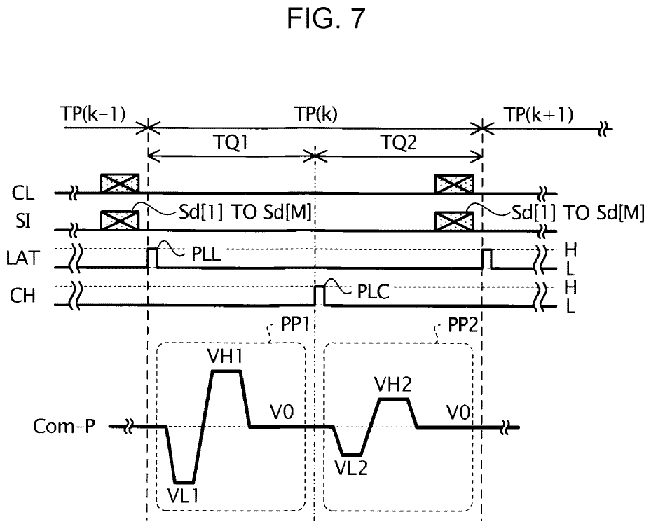

Hereinafter, the operation of the head unit 3 will be described with reference to FIGS. 7 to 12.

In the present embodiment, when the ink jet printer 1 executes the print process, the charging process, or the inspection process, one or a plurality of unit periods TP are set as operation periods of the ink jet printer 1. The ink jet printer 1 according to the present embodiment can drive each ejection portion D[m] for the print process, the charging process, or the inspection process in each unit period TP. Note that in the following description, among K consecutive unit periods TP, a k-th unit period TP may be referred to as a unit period TP(k). Here, the value K is a natural number satisfying “K≥1”, and the variable k is a natural number satisfying “1≤k≤K”.

FIG. 7 is a timing chart illustrating an example of various signals such as the drive signal Com supplied to the head unit 3 in the unit period TP(k) when the print process is executed in the unit period TP(k).

As illustrated in FIG. 7, when the print process is executed, the control unit 2 outputs the latch signal LAT having a plurality of pulses PLL. As a result, the control unit 2 defines the unit period TP(k) as a period from the rise of the pulse PLL to the rise of the subsequent pulse PLL.

When the print process is executed, the control unit 2 outputs the change signal CH having a pulse PLC in the unit period TP(k). As a result, the control unit 2 divides the unit period TP(k) into a control period TQ1 from the rise of the pulse PLL to the rise of the pulse PLC and a control period TQ2 from the rise of the pulse PLC to the rise of the pulse PLL.

As illustrated in FIG. 7, the designation signal SI includes M individual designation signals Sd[1] to Sd[M] corresponding to the M ejection portions D[1] to D[M] in a one-to-one basis. Each of the individual designation signal Sd[m] designates an aspect of driving the ejection portion D[m] in each unit period TP(k) when the ink jet printer 1 executes the print process, the charging process, or the inspection process.

When the print process, the charging process, or the inspection process is executed, the control unit 2 supplies the designation signal SI including the M individual designation signals Sd[1] to Sd[M] to the coupling state designation circuit 310 in synchronization with the clock signal CL before the unit period TP(k). Further, when the print process, the charging process, or the inspection process is executed, the control unit 2 supplies the mode signal Mod to the coupling state designation circuit 310 before the unit period TP(k). Then, the coupling state designation circuit 310 generates the coupling state designation signal Qc[m] and the coupling state designation signal Qs[m] based on the individual designation signal Sd[m] in the unit period TP(k) in which the print process, the charging process, or the inspection process is executed. In the unit period TP(k) in which the print process, the charging process, or the inspection process is executed, the coupling state designation circuit 310 generates the coupling state designation signal Qf, the coupling state designation signal Q1, and the coupling state designation signal Q2 based on the mode signal Mod.

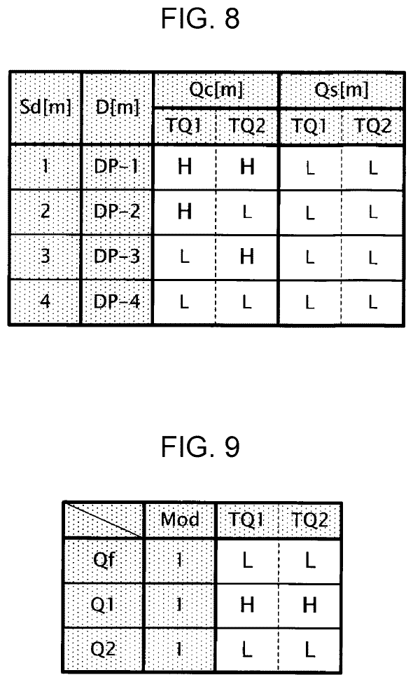

As illustrated in FIG. 8 to be described later, in the present embodiment, the individual designation signal Sd[m] can take any one value among four values, that is, a value of “1” that designates the ejection portion D[m] as a large dot forming ejection portion DP-1, a value of “2” that designates the ejection portion D[m] as a medium dot forming ejection portion DP-2, a value of “3” that designates the ejection portion D[m] as a small dot forming ejection portion DP-3, and a value of “4” that designates the ejection portion D[m] as a dot non-forming ejection portion DP-4 in the unit period TP[k] in which the print process is executed.

In this case, the large dot forming ejection portion DP-1 is an ejection portion D that forms a large dot in the unit period TP(k). The medium dot forming ejection portion DP-2 is the ejection portion D that forms a medium dot in the unit period TP(k). The small dot forming ejection portion DP-3 is the ejection portion D that forms a small dot in the unit period TP(k). The dot non-formation ejection portion DP-4 is the ejection portion D that does not form a dot in the unit period TP(k).

As illustrated in FIG. 7, when the print process is executed, the drive signal generation unit 4 supplies a print drive signal Com-P as the drive signal Com in each unit period TP(k). The print drive signal Com-P has a waveform PP1 and a waveform PP2 provided in each unit period TP(k). The waveform PP1 is a waveform provided in the control period TQ1 of the unit period TP(k), and is a waveform that returns to a reference potential V0 via a potential VL1 lower than the reference potential V0 and a potential VH1 higher than the reference potential V0 from the reference potential V0. When the supply drive signal Vin[m] having the waveform PP1 is supplied to the ejection portion D[m], the waveform PP1 is defined such that ink corresponding to an ink amount ξ1 is ejected from the ejection portion D[m]. The waveform PP2 is a waveform provided in the control period TQ2 of the unit period TP(k), and is a waveform that returns to the reference potential V0 via a potential VL2 lower than the reference potential V0 and a potential VH2 higher than the reference potential V0 from the reference potential V0. When the supply drive signal Vin[m] having the waveform PP2 is supplied to the ejection portion D[m], the waveform PP2 is defined such that ink corresponding to the ink amount ξ2 is ejected from the ejection portion D[m]. Note that in the present embodiment, it is assumed that the large dot is formed of ink in the sum of the ink amount ξ1 and the ink amount ξ2, the medium dot is formed of ink in the sum of the ink amount ξ1, and the small dot is formed of ink in the ink amount ξ2.

In addition, in the present embodiment, as an example, it is assumed that when the potential of the supply drive signal Vin[m] supplied to the ejection portion D[m] is high, the volume of the cavity CV[m] provided in the ejection portion D[m] is small as compared with a case of a low potential. Therefore, when the ejection portion D [m] is driven by the supply drive signal Vin[m] having the waveform PP1 or the waveform PP2, since the potential of the supply drive signal Vin[m] changes from a low potential to a high potential, the ink in the ejection portion D [m] is ejected from the nozzle N.

FIG. 8 is an explanatory view illustrating an example of the operation of the coupling state designation circuit 310 in the unit period TP(k) in which the print process is executed.

As illustrated in FIG. 8, when the individual designation signal Sd[m] indicates the value “1” that designates the ejection portion D[m] as the large dot forming ejection portion DP-1 in the unit period TP(k), the coupling state designation circuit 310 maintains the coupling state designation signal Qc[m] at a high level over the unit period TP(k). In this case, the switch Wc[m] is turned on over the unit period TP(k). Therefore, the ejection portion D[m] is driven by the supply drive signal Vin[m] having the waveform PP1 and the waveform PP2 in the unit period TP(k), and ejects ink in the sum of the ink amount ξ1 and the ink amount ξ2 which is an amount corresponding to the large dot. Further, when the individual designation signal Sd[m] indicates the value “2” that designates the ejection portion D[m] as the medium dot forming ejection portion DP-2 in the unit period TP(k), the coupling state designation circuit 310 maintains the coupling state designation signal Qc[m] at a high level in the control period TQ1. In this case, the switch Wc[m] is turned on in the control period TQ1. Therefore, the ejection portion D[m] is driven by the supply drive signal Vin[m] having the waveform PP1 in the control period TQ1, and ejects the ink in the ink amount ξ1 which is an amount corresponding to the medium dot.

Further, when the individual designation signal Sd[m] indicates the value “3” that designates the ejection portion D[m] as the small dot forming ejection portion DP-3 in the unit period TP(k), the coupling state designation circuit 310 maintains the coupling state designation signal Qc[m] at a high level in the control period TQ2. In this case, the switch Wc[m] is turned on in the control period TQ2. Therefore, the ejection portion D[m] is driven by the supply drive signal Vin[m] having the waveform PP2 in the control period TQ2, and ejects the ink in the ink amount ξ2 which is an amount corresponding to the small dot.

Further, when the individual designation signal Sd[m] indicates the value “4” that designates the ejection portion D[m] as the dot non-formation ejection portion DP-4 in the unit period TP(k), the coupling state designation circuit 310 maintains the coupling state designation signal Qc[m] and the coupling state designation signal Qs[m] at a low level over the unit period TP(k). In this case, the switch Wc[m] and the switch Ws[m] are turned off over the unit period TP(k). Therefore, the ejection portion D[m] does not supply the supply drive signal Vin[m] in the unit period TP(k), and does not eject the ink from the ejection portion D[m].

FIG. 9 is an explanatory view illustrating an example of the operation of the coupling state designation circuit 310 in the unit period TP(k) in which the print process is executed.

As illustrated in FIG. 9, when the print process is executed and the mode signal Mod indicates the value “1” indicating that the print process is executed, the coupling state designation circuit 310 maintains the coupling state designation signal Qf at a low level over the unit period TP(k), maintains the coupling state designation signal Q1 at a high level over the unit period TP(k), and maintains the coupling state designation signal Q2 at a low level over the unit period TP(k). Therefore, when the print process is executed, the switch Wf is turned off over the unit period TP(k), the switch W1 is turned on over the unit period TP(k), and the switch W2 is turned off over the unit period TP(k).

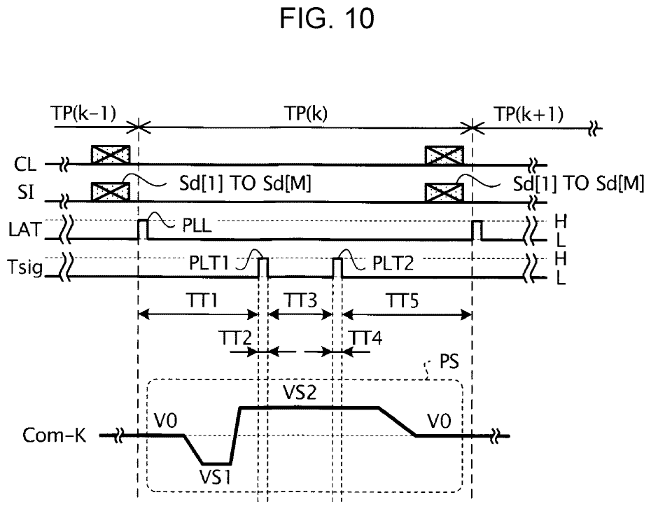

FIG. 10 is a timing chart illustrating an example of various signals such as the drive signal Com supplied to the head unit 3 in the unit period TP(k) when the non-print process (that is, the charging process or the inspection process) is executed in the unit period TP(k).

As illustrated in FIG. 10, when the non-print process is executed, the control unit 2 outputs the latch signal LAT having a plurality of pulses PLL. As a result, the control unit 2 defines the unit period TP(k) as a period from the rise of the pulse PLL to the rise of the subsequent pulse PLL.

When the non-print process is executed, the control unit 2 outputs a period designation signal Tsig having a pulse PLT1 and a pulse PLT2 in the unit period TP(k). As a result, the control unit 2 divides the unit period TP(k) into a control period TT1 from the rise of the pulse PLL to the rise of the pulse PLT1, a control period TT2 from the rise of the pulse PLT1 to the fall of the pulse PLT1, a control period TT3 from the fall of the pulse PLT1 to the rise of the pulse PLT2, a control period TT4 from the rise of the pulse PLT2 to the fall of the pulse PLT2, and a control period TT5 from the fall of the pulse PLT2 to the rise of the pulse PLL.

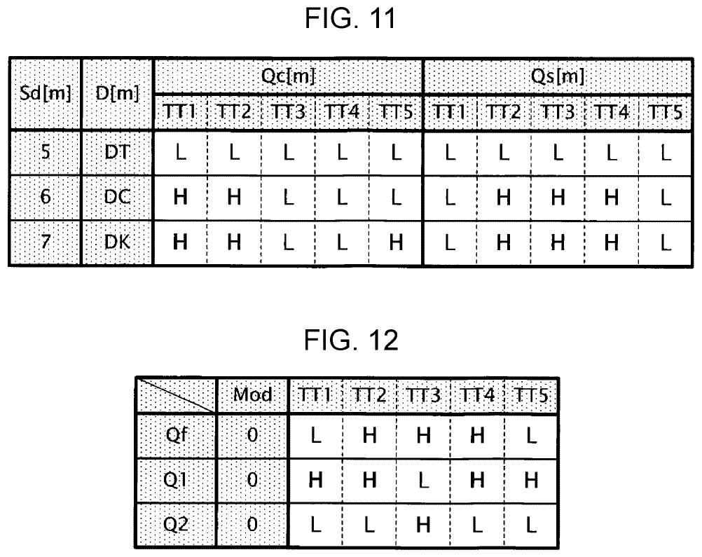

As illustrated in FIG. 11 described later, in the present embodiment, the individual designation signal Sd[m] can take any one value among three values, that is, a value “5” that designates the ejection portion D[m] as a standby ejection portion DT, a value “6” that designates the ejection portion D[m] as a charging path ejection portion DC, and a value “7” that designates the ejection portion D[m] as an inspection target ejection portion DK in the unit period TP(k) in which the non-print process is executed.

Here, the standby ejection portion DT is an ejection portion D that is not designated as the charging path ejection portion DC and is not designated as the inspection target ejection portion DK in the non-print process.

The charging path ejection portion DC is an ejection portion D used as a charging path of the parasitic capacitance generated on the supply path of the electrode potential signal VX[m] in the charging process.

The inspection target ejection portion DK is an ejection portion D that is an inspection target by the inspection unit 5 in the inspection process.

Note that in the present embodiment, it is assumed that the ink jet printer 1 can selectively execute one of the charging process and the inspection process as the non-print process in each unit period TP(k).

In addition, as described above, in the present embodiment, it is assumed that the ink jet printer 1 can selectively execute one of a low-speed charging process and a high-speed charging process as the charging process in each unit period TP(k).

In the present embodiment, it is assumed that in the unit period TP(k) in which the low-speed charging process is executed, all of the M ejection portions D[1] to D[M] are designated as the standby ejection portion DT.

In the present embodiment, it is assumed that in the unit period TP(k) in which the high-speed charging process is executed, one ejection portion D among the M ejection portions D[1] to D[M] is designated as the charging path ejection portion DC, and the remaining (M-1) ejection portions D other than the ejection portion D designated as the charging path ejection portion DC are designated as the standby ejection portions DT. Meanwhile, the present disclosure is not limited to such an aspect. In the unit period TP(k) in which the high-speed charging process is executed, two or more ejection portions D may be designated as the charging path ejection portion DC, and the remaining ejection portions D other than the two or more ejection portions D designated as the charging path ejection portion DC may be designated as the standby ejection portion DT.

In the present embodiment, it is assumed that in the unit period TP(k) in which the inspection process is executed, one ejection portion D is designated as the inspection target ejection portion DK, and the remaining (M-1) ejection portions D other than the ejection portion D designated as the inspection target ejection portion DK are designated as the standby ejection portions DT.

Note that in the present embodiment, it is assumed that the parasitic capacitance that is the target of charging in the charging process is capacitance that is parasitic on the switch Ws[m]. Meanwhile, the present disclosure is not limited to such an aspect. The parasitic capacitance that is a charging target in the charging process may be capacitance that is parasitic on the wiring Ls.

As illustrated in FIG. 10, when the non-print process is executed, the drive signal generation unit 4 supplies the inspection drive signal Com-K as the drive signal Com in each unit period TP(k). The inspection drive signal Com-K has a waveform PS provided for each unit period TP(k). The waveform PS is a waveform that changes from the reference potential V0 to a potential VS2 having a potential higher than the reference potential V0 via a potential VS1 having a potential lower than the reference potential V0 in the control period TT1, maintains the potential VS2 in the control period TT2, the control period TT3, and the control period TT4, and changes from the potential VS2 to the reference potential V0 in the control period TT5. Note that in the present embodiment, the waveform PS is defined such that the ink is not ejected from the ejection portion D[m] when the supply drive signal Vin[m] having the waveform PS is supplied to the ejection portion D[m].

FIG. 11 is an explanatory view illustrating an example of the operation of the coupling state designation circuit 310 in the unit period TP(k) in which the non-print process (that is, the charging process or the inspection process) is performed.

As illustrated in FIG. 11, when the individual designation signal Sd[m] indicates a value “5” that designates the ejection portion D[m] as the standby ejection portion DT in the unit period TP(k), the coupling state designation circuit 310 maintains the coupling state designation signal Qc[m] and the coupling state designation signal Qs[m] at a low level over the unit period TP(k). In this case, the switch Wc[m] and the switch Ws[m] are turned off over the unit period TP(k). Therefore, the supply drive signal Vin[m] is not supplied to the ejection portion D[m] in the unit period TP(k), and the potential of the upper electrode Zu[m] does not affect the potential of the wiring Ls.

In addition, when the individual designation signal Sd[m] indicates a value “6” that designates the ejection portion D[m] as the charging path ejection portion DC in the unit period TP(k), the coupling state designation circuit 310 maintains the coupling state designation signal Qc[m] at a high level in the control period TT1 and the control period TT2, and maintains the coupling state designation signal Qs[m] at a high level in the control period TT2, the control period TT3, and the control period TT4. In this case, the switch Wc[m] is turned on in the control period TT1 and the control period TT2, and the switch Ws[m] is turned on in the control period TT2, the control period TT3, and the control period TT4.

In addition, when the individual designation signal Sd[m] indicates a value “7” that designates the ejection portion D[m] as the inspection target ejection portion DK in the unit period TP(k), the coupling state designation circuit 310 maintains the coupling state designation signal Qc[m] at a high level in the control period TT1, the control period TT2, and the control period TT5, and maintains the coupling state designation signal Qs[m] at a high level in the control period TT2, the control period TT3, and the control period TT4. In this case, the switch Wc[m] is turned on in the control period TT1, the control period TT2, and the control period TT5, and the switch Ws[m] is turned on in the control period TT2, the control period TT3, and the control period TT4.

FIG. 12 is an explanatory view illustrating an example of the operation of the coupling state designation circuit 310 in the unit period TP(k) in which the non-print process (that is, the charging process or the inspection process) is executed.

As illustrated in FIG. 12, when the non-print process is executed and the mode signal Mod indicates a value “0” indicating that the non-print process is executed, the coupling state designation circuit 310 maintains the coupling state designation signal Qf at a high level in the control period TT2, the control period TT3, and the control period TT4, maintains the coupling state designation signal Q1 at a high level in the control period TT1, the control period TT2, the control period TT4, and the control period TT5, and maintains the coupling state designation signal Q2 at a high level in the control period TT3. Therefore, when the print process is executed, the switch Wf is turned on in the control period TT2, the control period TT3, and the control period TT4, the switch W1 is turned on in the control period TT1, the control period TT2, the control period TT4, and the control period TT5, and the switch W2 is turned on in the control period TT3.

### 4. Outline of Non-Print Process

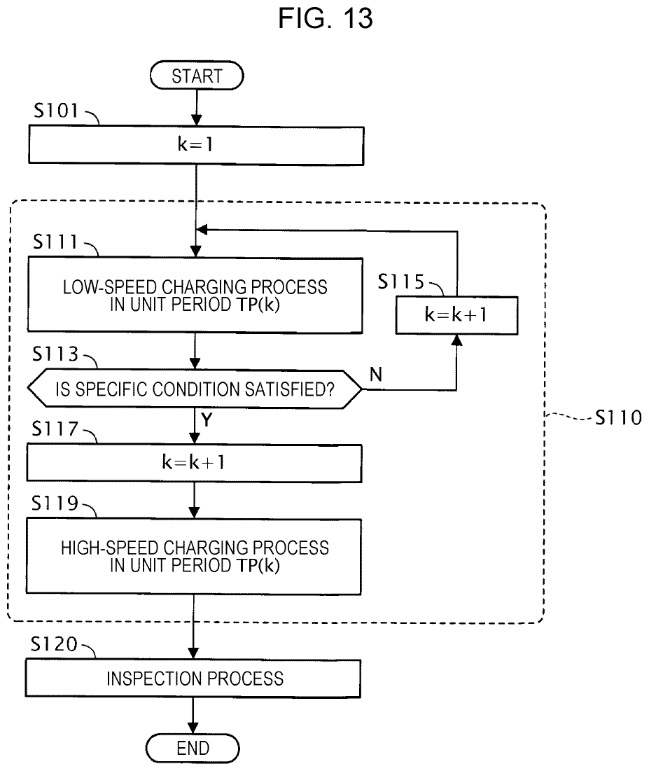

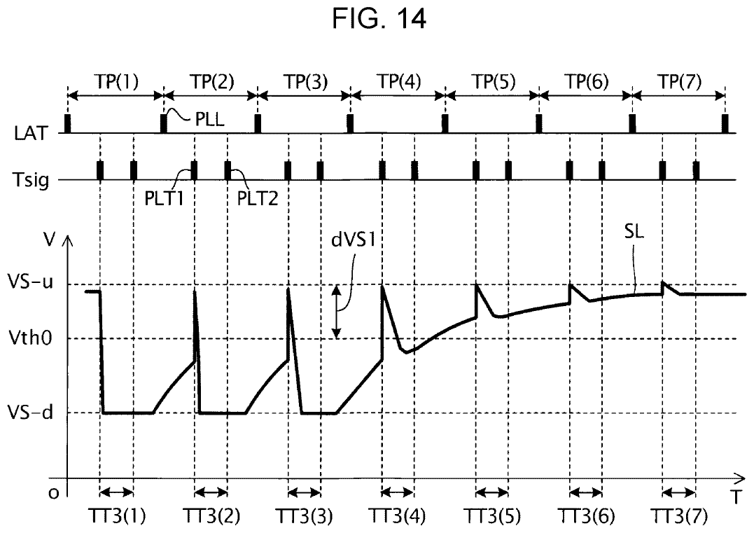

Hereinafter, an outline of the non-print process will be described with reference to FIGS. 13 and 14.

FIG. 13 is a flowchart illustrating an example of the operation of the ink jet printer 1 when the charging process and the inspection process are executed as the non-print process. Note that in the present embodiment, it is assumed that the non-print process is a process including the low-speed charging process, the high-speed charging process, and the inspection process.

As illustrated in FIG. 13, when the non-print process is initiated, the control unit 2 sets the variable k to “1” (S101).

Next, the ink jet printer 1 executes the charging process (S110).

Specifically, first, the ink jet printer 1 executes the low-speed charging process as the charging process in the unit period TP(k) (S111).

Next, the determination unit 6 provided in the ink jet printer 1 determines whether or not the detection potential signal SL satisfies a specific condition as the charging process (S113). In the following description, in step S113, a process in which the determination unit 6 determines whether or not the specific condition is satisfied may be referred to as a specific condition determination process. Note that the specific condition will be described later.

Then, when the result of the determination in Step S113 is negative, the ink jet printer 1 adds “1” to the variable k (S115), and the process proceeds to Step S111.

On the other hand, when the result of the determination in step S113 is positive, the ink jet printer 1 adds “1” to the variable k (S117) and the process proceeds to step S119.

Next, the ink jet printer 1 executes the high-speed charging process as the charging process in the unit period TP(k) (S119) and terminates the charging process.

Thereafter, the ink jet printer 1 executes the inspection process in the unit period TP(k) (S120) and terminates the non-print process.

FIG. 14 is an explanatory view for explaining a change in a potential of the detection potential signal SL and a specific condition when the non-print process is executed. Note that in FIG. 14, it is assumed that the low-speed charging process is repeatedly executed until the specific condition is satisfied in seven unit periods TP(1) to TP(7). Then, it is assumed that the capacitance that is parasitic on the switch Ws[m] is not charged at the start point of the unit period TP(1). In addition, in the following description, the control period TT3 included in the unit period TP(k) may be referred to as a control period TT3(k).

As illustrated in FIG. 14, when the non-print process is initiated and the low-speed charging process is executed in the unit period TP(1), the potential of the detection potential signal SL is in a state in which the capacitance that is parasitic on the switch Ws[m] is not charged in the control period TT3(1), and thus the potential largely fluctuates between an upper limit potential VS-u and a lower limit potential VS-d. Similarly, the potential of the detection potential signal SL is in a state in which charging of the capacitance that is parasitic on the switch Ws[m] is not completed in the unit period TP(2) and the unit period TP(3), and thus the potential largely fluctuates between the upper limit potential VS-u and the lower limit potential VS-d.

Thereafter, in the unit period TP(4), charging of the capacitance that is parasitic on the switch Ws[m] progresses, a minimum potential of the detection potential signal SL becomes a potential higher than the lower limit potential VS-d, and a fluctuation width of the potential of the detection potential signal SL in the unit period TP(4) becomes smaller than a fluctuation width in the unit periods TP(1) to TP(3).

Then, in the unit periods TP(5) to TP(7), charging of the capacitance that is parasitic on the switch Ws[m] further proceeds, and thus the minimum potential of the detection potential signal SL becomes equal to or higher than a threshold potential Vth0, and the fluctuation width of the potential of the detection potential signal SL in the unit periods TP(5) to TP(7) becomes equal to or less than the allowable fluctuation amount dVS1. In the present embodiment, a condition that a fluctuation amount in the potential of the detection potential signal SL in the unit period TP(k) is equal to or less than an allowable fluctuation amount dVS1 is adopted as a specific condition. That is, in the present embodiment, the specific condition is satisfied when the fluctuation amount in the potential of the detection potential signal SL in the unit period TP(k) is equal to or less than the allowable fluctuation amount dVS1. In the example illustrated in FIG. 14, since the potential fluctuation amount of the detection potential signal SL in the unit period TP(5) is equal to or less than the allowable fluctuation amount dVS1, the specific condition is satisfied in the unit period TP(5).

Here, the allowable fluctuation amount dVS1 is a potential fluctuation amount of the node Nd4 corresponding to a case where a maximum rated current flows through the switch Ws[m]. Specifically, the allowable fluctuation amount is a potential fluctuation amount of the node Nd4 in the unit period TP(k) when the switch Ws[m] is turned on in the unit period TP(k) and the maximum rated current of the switch Ws[m] flows. Meanwhile, the present disclosure is not limited to such an aspect. The allowable fluctuation amount dVS1 may be, for example, a value obtained by multiplying a potential difference between the upper limit potential VS-u and the lower limit potential VS-d by a coefficient of less than 1. The allowable fluctuation amount dVS1 may be, for example, a value obtained by multiplying the potential difference between the upper limit potential VS-u and the lower limit potential VS-d by “0.5”.

In addition, the threshold potential Vth0 is a potential obtained by subtracting the allowable fluctuation amount dVS1 from the upper limit potential VS-u. In the present embodiment, it is assumed that the threshold potential Vth0 is higher than the lower limit potential VS-d.

The determination unit 6 determines whether or not the potential fluctuation amount of the detection potential signal SL in the unit period TP(k) (more exactly, the control period TT3(k)) is equal to or less than the allowable fluctuation amount dVS1 based on the detection potential signal SL. When the potential fluctuation amount of the detection potential signal SL in the unit period TP(k) is equal to or less than the allowable fluctuation amount dVS1, the charging termination designation signal ST indicating a value “1” indicating that the low-speed charging process is terminated is output. On the other hand, when the potential fluctuation amount of the detection potential signal SL in the unit period TP(k) is larger than the allowable fluctuation amount dVS1, the charging termination designation signal ST indicating a value “0” indicating that the low-speed charging process is to be continued is output.

Note that in the present embodiment, a period from the initiation of the non-print process to the initiation of the inspection process is an example of a “preparation period”. For example, in the example illustrated in FIG. 14, when the low-speed charging process is executed in a period from the unit period TP(1) to the unit period TP(5), the specific condition is satisfied in the unit period TP(5), the high-speed charging process is executed in the unit period TP(6), and the inspection process is executed in the unit period TP(7), a period from the unit period TP(1) to the unit period TP(6) corresponds to the “preparation period”.

In addition, in the present embodiment, the operation of the supply circuit 31 when the low-speed charging process is executed is an example of a “first charging operation”, the operation of the supply circuit 31 when the high-speed charging process is executed is an example of a “second charging operation”, the allowable fluctuation amount dVS1 is an example of a “predetermined amount”, the upper limit potential VS-u is an example of a “first threshold value”, the threshold potential Vth0 is an example of a “second threshold value”, the condition that the detection potential signal SL maintains a potential equal to or lower than the upper limit potential VS-u in the unit period TP(k) is an example of a “first condition”, and the condition that the detection potential signal SL maintains a potential equal to or higher than the threshold potential Vth0 in the unit period TP(k) is an example of a “second condition”.

### 5. Outline of Low-Speed Charging Process

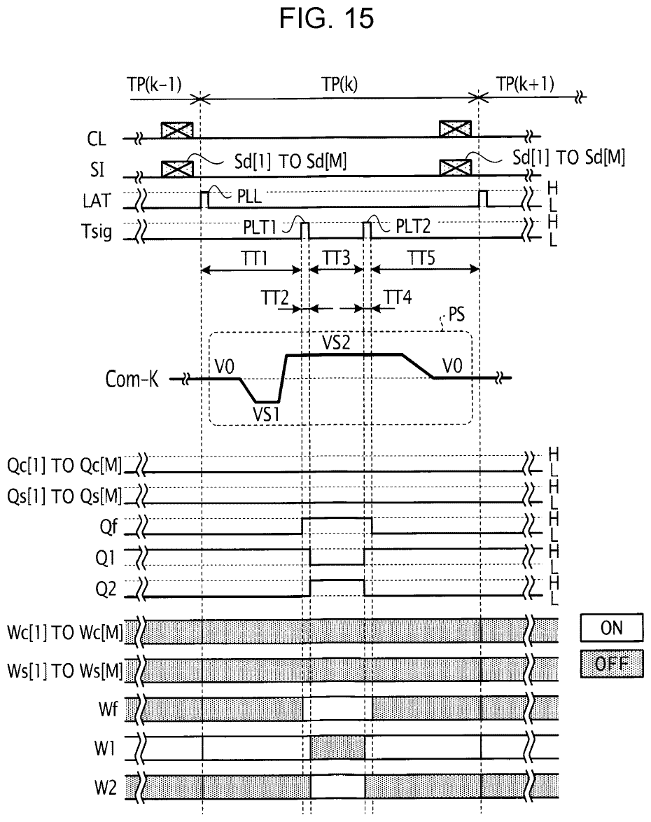

Hereinafter, an outline of the low-speed charging process will be described with reference to FIGS. 15 to 20.

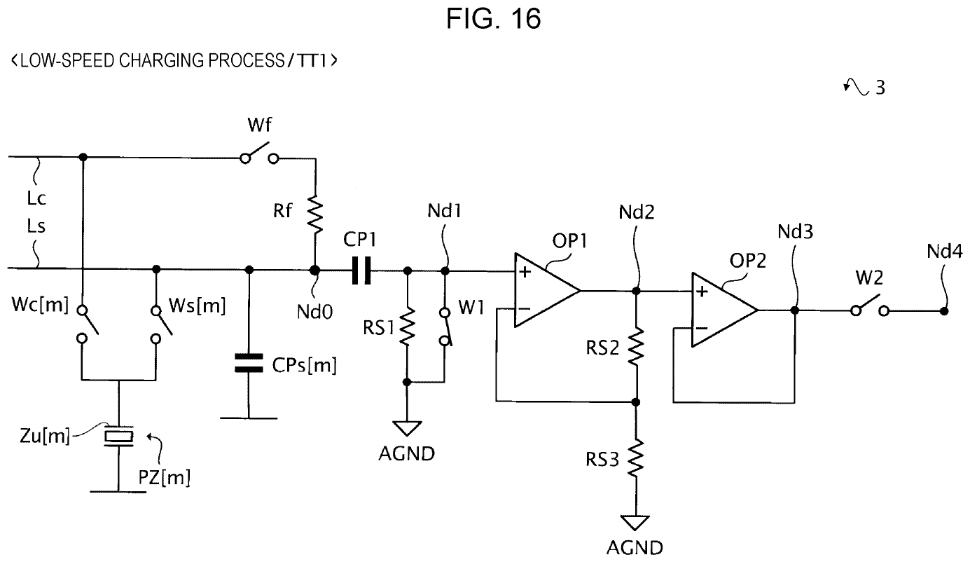

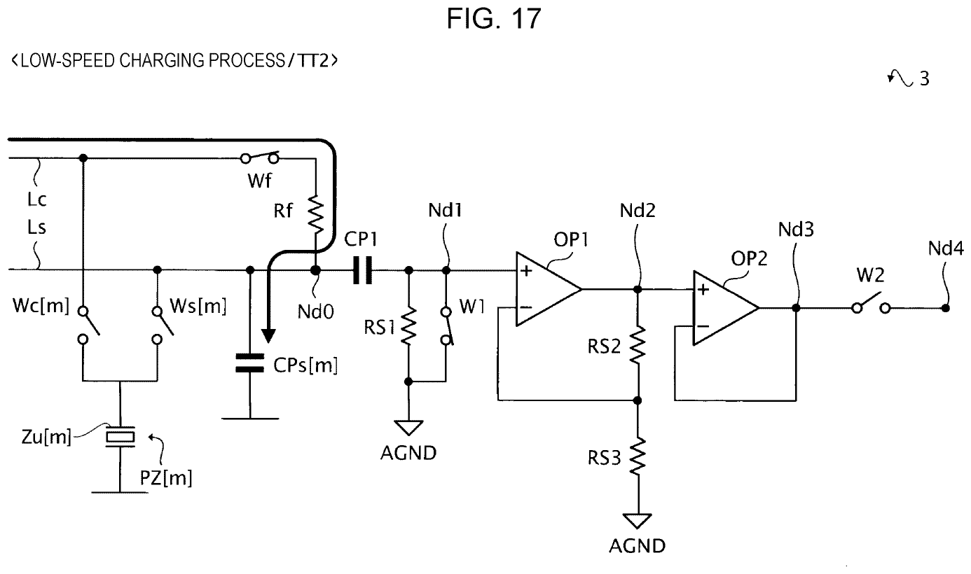

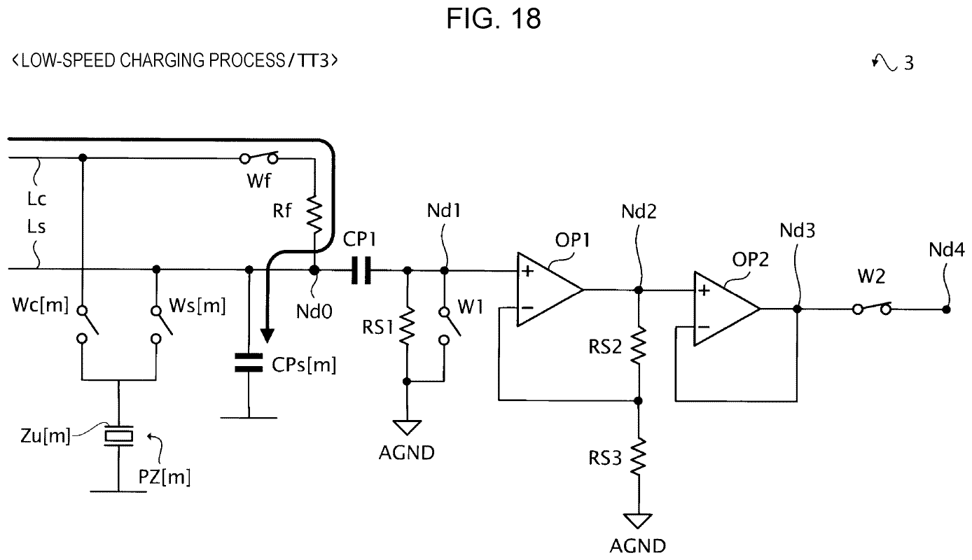

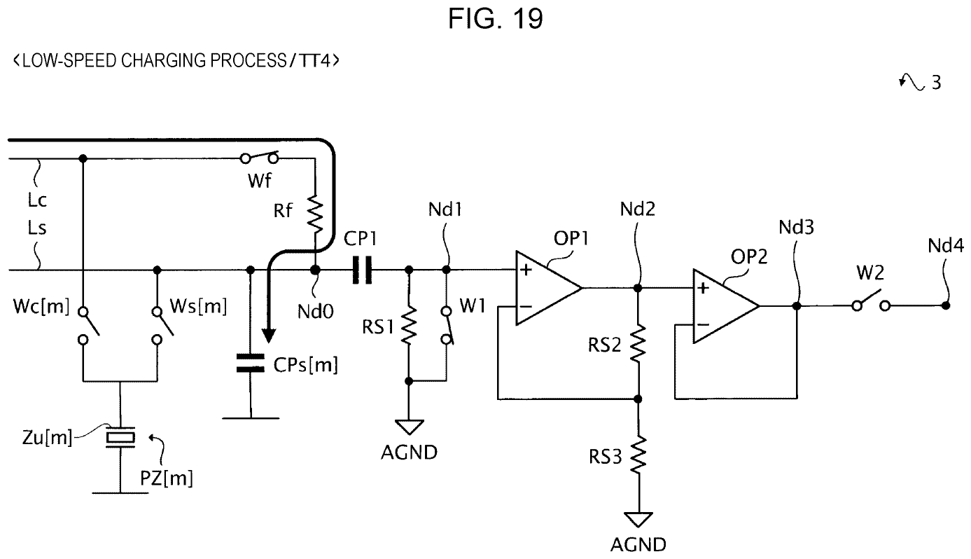

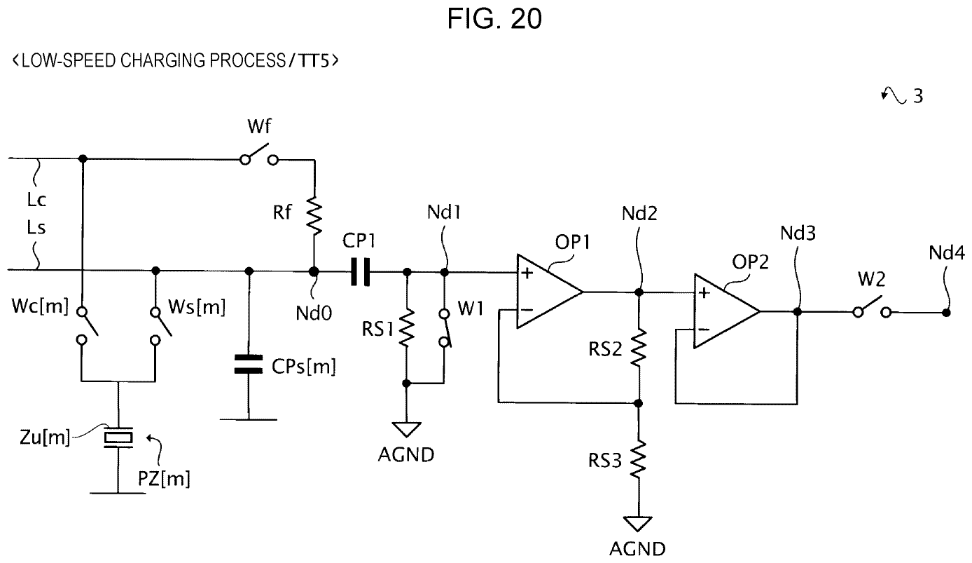

FIG. 15 is a timing chart for explaining an example of the operation of the head unit 3 when the low-speed charging process is executed in the ink jet printer 1. Further, FIGS. 16 to 20 are circuit diagrams for explaining an example of the operation of the head unit 3 when the low-speed charging process is executed in the ink jet printer 1. Specifically, FIG. 16 is a diagram illustrating an example of the operation of the head unit 3 in the control period TT1 of the unit period TP(k) in which the low-speed charging process is executed, FIG. 17 is a diagram illustrating an example of the operation of the head unit 3 in the control period TT2 of the unit period TP(k) in which the low-speed charging process is executed, FIG. 18 is a diagram illustrating an example of the operation of the head unit 3 in the control period TT3 of the unit period TP(k) in which the low-speed charging process is executed, FIG. 19 is a diagram illustrating an example of the operation of the head unit 3 in the control period TT4 of the unit period TP(k) in which the low-speed charging process is executed, and FIG. 20 is a diagram illustrating an example of the operation of the head unit 3 in the control period TT5 of the unit period TP(k) in which the low-speed charging process is executed.

As illustrated in FIG. 15, in the control period TT1 of the unit period TP(k) in which the low-speed charging process is executed, the coupling state designation signals Qc[1] to Qc[M] maintain a low level, the coupling state designation signals Qs[1] to Qs[M] maintain a low level, the coupling state designation signal Qf maintains a low level, the coupling state designation signal Q1 maintains a high level, and the coupling state designation signal Q2 maintains a low level. Therefore, as illustrated in FIG. 16, in the control period TT1 of the unit period TP(k), the switches Wc[1] to Wc[M] maintain an OFF state, the switches Ws[m] to Ws[M] maintain an OFF state, the switch Wf maintains an OFF state, the switch W1 maintains an ON state, and the switch W2 maintains an OFF state.

Therefore, in the control period TT1 of the unit period TP(k) in which the low-speed charging process is executed, the node Nd0 and the wiring Ls of the detection circuit 33 maintain a state in which the node Nd0 and the wiring Ls are not electrically coupled to the wiring Lc and the piezoelectric element PZ[m].

As illustrated in FIG. 15, in the control period TT2 of the unit period TP(k) in which the low-speed charging process is executed, the coupling state designation signals Qc[1] to Qc[M] maintain a low level, the coupling state designation signals Qs[1] to Qs[M] maintain a low level, the coupling state designation signal Qf maintains a high level, the coupling state designation signal Q1 maintains a high level, and the coupling state designation signal Q2 maintains a low level. Therefore, as illustrated in FIG. 17, in the control period TT2 of the unit period TP(k), the switches Wc[1] to Wc[M] maintain an OFF state, the switches Ws[m] to Ws[M] maintain an OFF state, the switch Wf maintains an ON state, the switch W1 maintains an ON state, and the switch W2 maintains an OFF state.

Therefore, in the control period TT2 of the unit period TP(k) in which the low-speed charging process is executed, the node Nd0 and the wiring Ls of the detection circuit 33 are electrically coupled to the wiring Lc via the switch Wf and the resistor Rf. In the control period TT2 of the unit period TP(k), the potential of the drive signal Com is the potential VS2. Therefore, in the control period TT2 of the unit period TP(k) in which the low-speed charging process is executed, the drive signal Com of the potential VS2 supplied to the wiring Lc is supplied to the parasitic capacitance CPs[m] that is parasitic on the switch Ws[m], and the parasitic capacitance CPs[m] is charged. Note that in the present embodiment, it is assumed that a resistance value of the resistor Rf is a sufficiently large value as compared with an on-resistance of the switch Wc[m] and an on-resistance of the switch Ws[m]. Specifically, as the resistor Rf, a resistor having a resistance value of approximately 10 kΩ to 9000 kΩ may be adopted.

As illustrated in FIG. 15, in the control period TT3 of the unit period TP(k) in which the low-speed charging process is executed, the coupling state designation signals Qc[1] to Qc[M] maintain a low level, the coupling state designation signals Qs[1] to Qs[M] maintain a low level, the coupling state designation signal Qf maintains a high level, the coupling state designation signal Q1 maintains a low level, and the coupling state designation signal Q2 maintains a high level. Therefore, as illustrated in FIG. 18, in the control period TT3 of the unit period TP(k), the switches Wc[1] to Wc[M] maintain an OFF state, the switches Ws[m] to Ws[M] maintain an OFF state, the switch Wf maintains an ON state, the switch W1 maintains an OFF state, and the switch W2 maintains an ON state.

Therefore, in the control period TT3 of the unit period TP(k) in which the low-speed charging process is executed, the node Nd0 and the wiring Ls of the detection circuit 33 are electrically coupled to the wiring Lc via the switch Wf and the resistor Rf. In the control period TT3 of the unit period TP(k), the potential of the drive signal Com is the potential VS2. Therefore, in the control period TT3 of the unit period TP(k) in which the low-speed charging process is executed, the drive signal Com of the potential VS2 supplied to the wiring Lc is supplied to the parasitic capacitance CPs[m] that is parasitic on the switch Ws[m], and the parasitic capacitance CPs[m] is charged. Further, in the control period TT3 of the unit period TP(k) in which the low-speed charging process is executed, the switch W2 is turned on, and thus the node Nd3 and the node Nd4 are electrically coupled to each other. The node Nd3 is set to a potential corresponding to the potential of the node Nd0 coupled to the wiring Ls. Therefore, in the control period TT3 of the unit period TP(k) in which the low-speed charging process is executed, the detection potential signal SL having a potential corresponding to the potential of the node Nd0 coupled to the wiring Ls is output from the node Nd4.

As illustrated in FIG. 15, in the control period TT4 of the unit period TP(k) in which the low-speed charging process is executed, the coupling state designation signals Qc[1] to Qc[M] maintain a low level, the coupling state designation signals Qs[1] to Qs[M] maintain a low level, the coupling state designation signal Qf maintains a high level, the coupling state designation signal Q1 maintains a high level, and the coupling state designation signal Q2 maintains a low level. Therefore, as illustrated in FIG. 19, in the control period TT4 of the unit period TP(k), the switches Wc[1] to Wc[M] maintain an OFF state, the switches Ws[m] to Ws[M] maintain an OFF state, the switch Wf maintains an ON state, the switch W1 maintains an ON state, and the switch W2 maintains an OFF state.

Therefore, in the control period TT4 of the unit period TP(k) in which the low-speed charging process is executed, the node Nd0 and the wiring Ls of the detection circuit 33 are electrically coupled to the wiring Lc via the switch Wf and the resistor Rf. In the control period TT4 of the unit period TP(k), the potential of the drive signal Com is the potential VS2. Therefore, in the control period TT4 of the unit period TP(k) in which the low-speed charging process is executed, the drive signal Com of the potential VS2 supplied to the wiring Lc is supplied to the parasitic capacitance CPs[m] that is parasitic on the switch Ws[m], and the parasitic capacitance CPs[m] is charged.

As illustrated in FIG. 15, in the control period TT5 of the unit period TP(k) in which the low-speed charging process is executed, the coupling state designation signals Qc[1] to Qc[M] maintain a low level, the coupling state designation signals Qs[1] to Qs[M] maintain a low level, the coupling state designation signal Qf maintains a low level, the coupling state designation signal Q1 maintains a high level, and the coupling state designation signal Q2 maintains a low level. Therefore, as illustrated in FIG. 20, in the control period TT5 of the unit period TP(k), the switches Wc[1] to Wc[M] maintain an OFF state, the switches Ws[m] to Ws[M] maintain an OFF state, the switch Wf maintains an OFF state, the switch W1 maintains an ON state, and the switch W2 maintains an OFF state.

Therefore, in the control period TT5 of the unit period TP(k) in which the low-speed charging process is executed, the node Nd0 and the wiring Ls of the detection circuit 33 maintain a state in which the node Nd0 and the wiring Ls are not electrically coupled to the wiring Lc and the piezoelectric element PZ[m].

As described above, according to the present embodiment, in the low-speed charging process, the parasitic capacitance CPs[m] is charged via the resistor Rf having a sufficiently large resistance value. Therefore, according to the present embodiment, a current equal to or greater than the maximum rated current can be suppressed from flowing to the switch Wc[m], the switch Ws[m], and the switch Wf in the low-speed charging process. That is, according to the present embodiment, in the low-speed charging process, excessive charging with respect to the parasitic capacitance CPs[m] can be suppressed, and a risk in which the switch Wc[m], the switch Ws[m], and the switch Wf fail due to execution of excessive charging with respect to the parasitic capacitance CPs[m] can be suppressed.

Further, according to the present embodiment, when the low-speed charging process is executed in the unit period TP(k), the determination unit 6 determines whether or not it is necessary to execute the low-speed charging process in a unit period TP(k+1) based on the detection potential signal SL. That is, according to the present embodiment, when the parasitic capacitance CPs[m] cannot be sufficiently charged by executing the low-speed charging process in the unit period TP(k), the low-speed charging process can be executed repeatedly in the unit period TP(k+1). Therefore, according to the present embodiment, occurrence of a situation in which the charging of the parasitic capacitance CPs[m] is insufficient can be suppressed.

Note that in the present embodiment, among the unit periods TP(k) in which the low-speed charging process is executed, a period from the control period TT2 to the control period TT4 is an example of the “charging period”.

### 6. Outline of High-Speed Charging Process

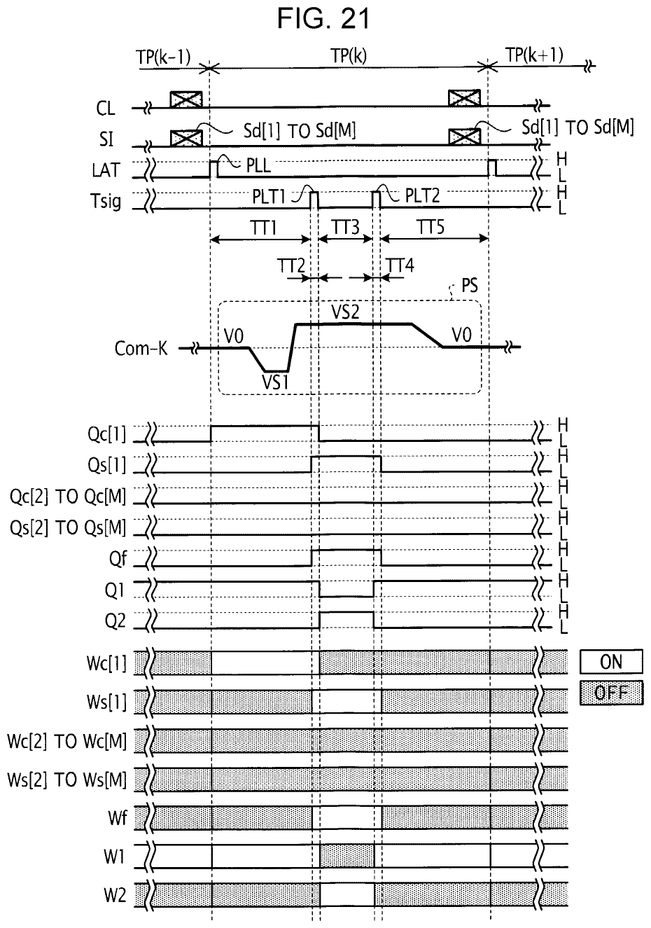

Hereinafter, an outline of the high-speed charging process will be described with reference to FIGS. 21 to 26.

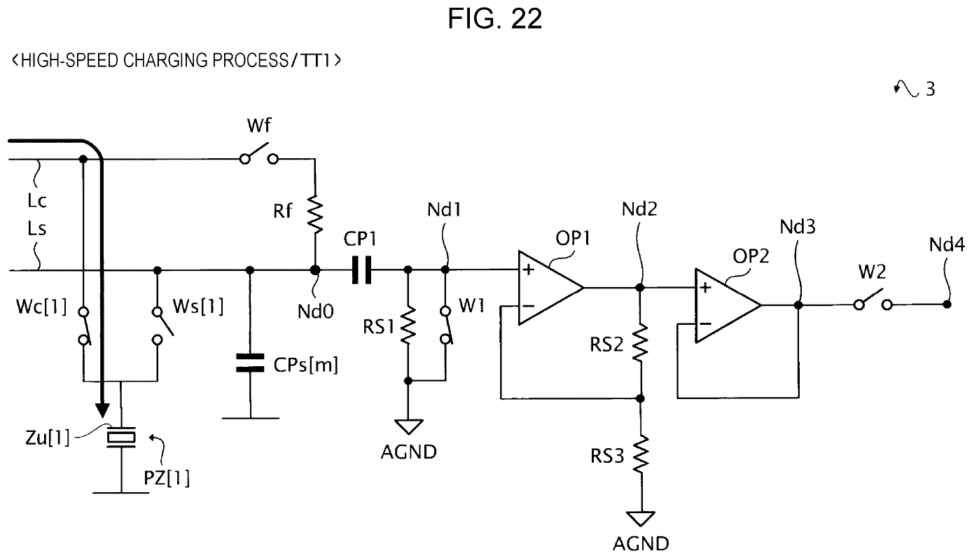

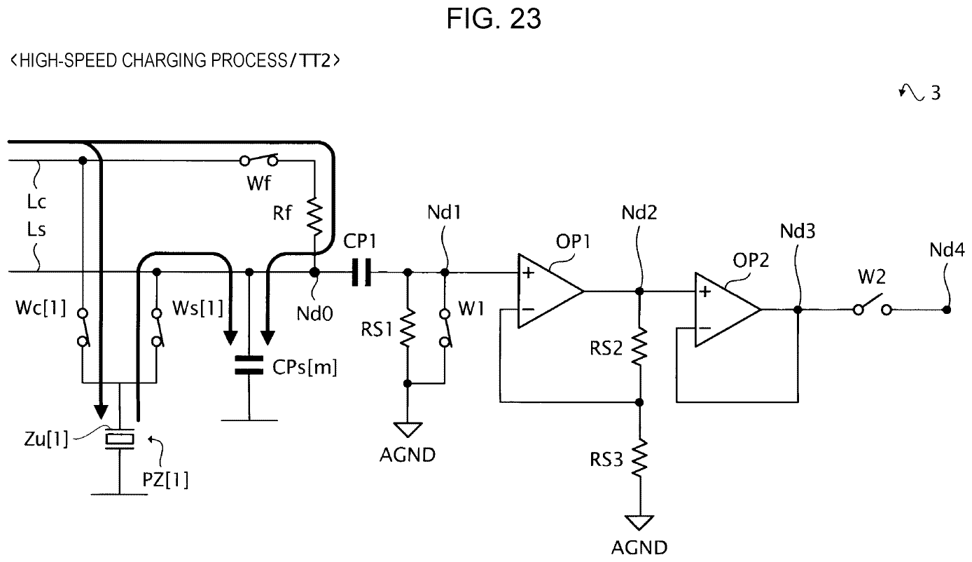

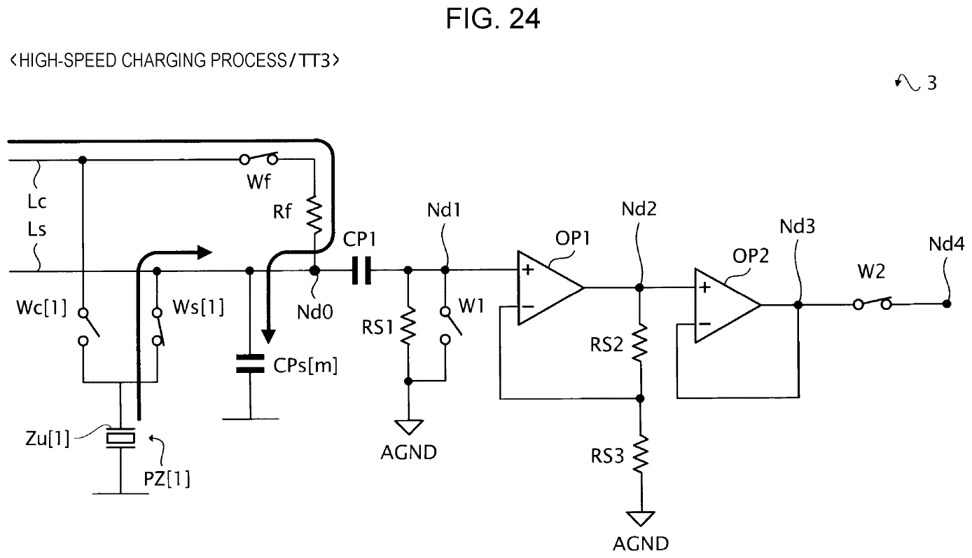

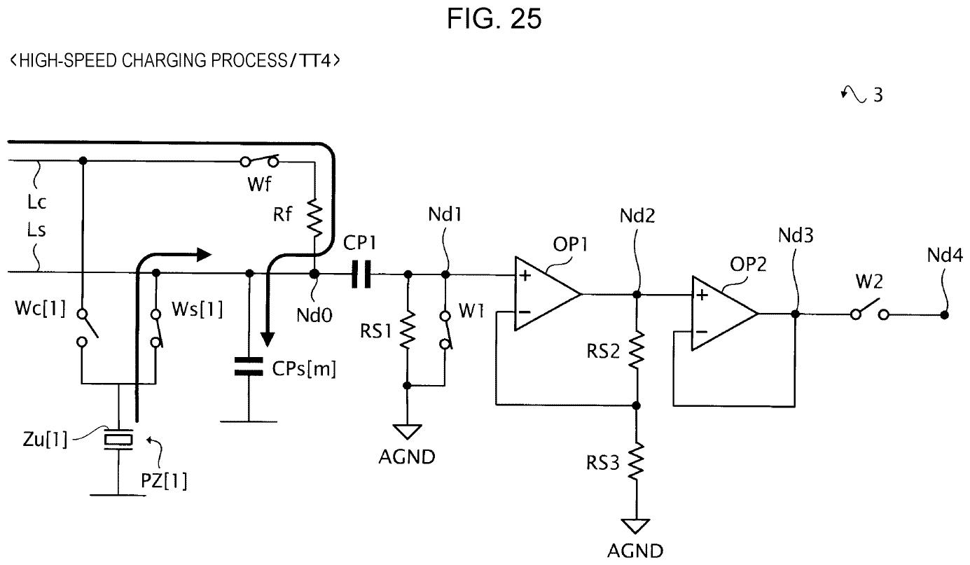

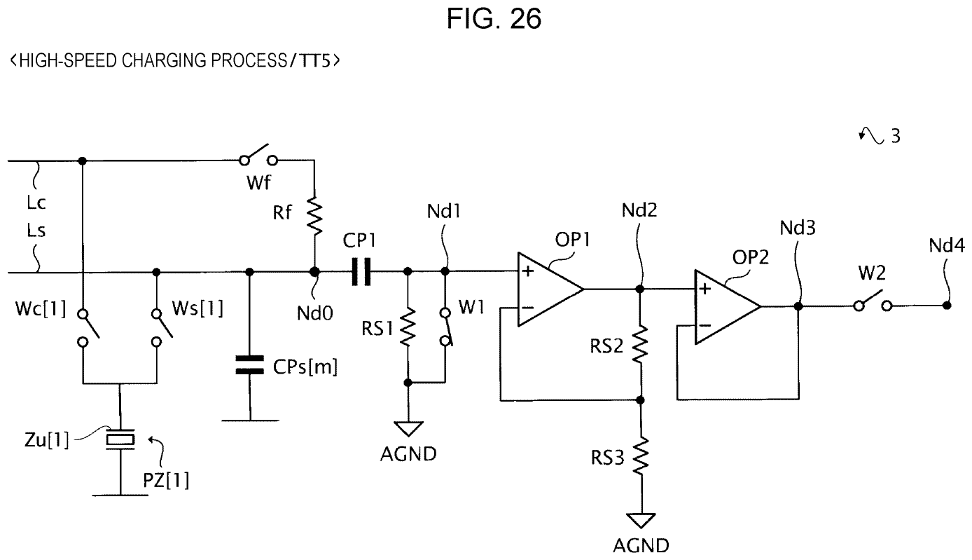

FIG. 21 is a timing chart for explaining an example of the operation of the head unit 3 when the high-speed charging process is executed in the ink jet printer 1. Further, FIGS. 22 to 26 are circuit diagrams for explaining an example of the operation of the head unit 3 when the high-speed charging process is executed in the ink jet printer 1. Specifically, FIG. 22 is a diagram illustrating an example of the operation of the head unit 3 in the control period TT1 of the unit period TP(k) in which the high-speed charging process is executed. FIG. 23 is a diagram illustrating an example of the operation of the head unit 3 in the control period TT2 of the unit period TP(k) in which the high-speed charging process is executed. FIG. 24 is a diagram illustrating an example of the operation of the head unit 3 in the control period TT3 of the unit period TP(k) in which the high-speed charging process is executed, FIG. 25 is a diagram illustrating an example of the operation of the head unit 3 in the control period TT4 of the unit period TP(k) in which the high-speed charging process is executed, and FIG. 26 is a diagram illustrating an example of the operation of the head unit 3 in the control period TT5 of the unit period TP(k) in which the high-speed charging process is executed. Note that in FIGS. 21 to 26, a case where the ejection portion D[1] is designated as the charging path ejection portion DC and the ejection portions D[2] to D[M] are designated as the standby ejection portion DT is assumed as an example.

As illustrated in FIG. 21, in the control period TT1 of the unit period TP(k) in which the high-speed charging process is executed, the coupling state designation signal Qc[1] maintains a high level, the coupling state designation signal Qs[1] maintains a low level, the coupling state designation signals Qc[2] to Qc[M] maintain a low level, the coupling state designation signals Qs[2] to Qs[M] maintain a low level, the coupling state designation signal Qf maintains a low level, the coupling state designation signal Q1 maintains a high level, and the coupling state designation signal Q2 maintains a low level. Therefore, as illustrated in FIG. 22, in the control period TT1 of the unit period TP(k), the switch Wc[1] maintains an ON state, the switch Ws[1] maintains an OFF state, the switches Wc[2] to Wc[M] maintain an OFF state, the switches Ws[2] to Ws[M] maintain an OFF state, the switch Wf maintains an OFF state, the switch W1 maintains an ON state, and the switch W2 maintains an OFF state.

Therefore, in the control period TT1 of the unit period TP(k) in which the high-speed charging process is executed, the drive signal Com is supplied from the wiring Lc to the upper electrode Zu[1] via the switch Wc[1], and as a result, the piezoelectric element PZ[1] is driven. In the control period TT1 of the unit period TP(k) in which the high-speed charging process is executed, the node Nd0 and the wiring Ls of the detection circuit 33 maintain a state in which the node Nd0 and the wiring Ls are not electrically coupled to the wiring Lc and the piezoelectric element PZ[m].

As illustrated in FIG. 21, in the control period TT2 of the unit period TP(k) in which the high-speed charging process is executed, the coupling state designation signal Qc[1] maintains a high level, the coupling state designation signal Qs[1] maintains a high level, the coupling state designation signals Qc[2] to Qc[M] maintain a low level, the coupling state designation signals Qs[2] to Qs[M] maintain a low level, the coupling state designation signal Qf maintains a high level, the coupling state designation signal Q1 maintains a high level, and the coupling state designation signal Q2 maintains a low level. Therefore, as illustrated in FIG. 23, in the control period TT2 of the unit period TP(k), the switch Wc[1] maintains an ON state, the switch Ws[1] maintains an ON state, the switches Wc[2] to Wc[M] maintain an OFF state, the switches Ws[2] to Ws[M] maintain an OFF state, the switch Wf maintains an ON state, the switch W1 maintains an ON state, and the switch W2 maintains an OFF state.

Therefore, in the control period TT2 of the unit period TP(k) in which the high-speed charging process is executed, the node Nd0 and the wiring Ls of the detection circuit 33 are electrically coupled to the wiring Lc via the switch Wf and the resistor Rf. In the control period TT2 of the unit period TP(k) in which the high-speed charging process is executed, the node Nd0 and the wiring Ls of the detection circuit 33 are electrically coupled to the wiring Lc via the switch Wc[1] and the switch Ws[1]. In the control period TT2 of the unit period TP(k) in which the high-speed charging process is executed, the potential of the drive signal Com is the potential VS2. Therefore, in the control period TT2 of the unit period TP(k) in which the high-speed charging process is executed, the drive signal Com of the potential VS2 supplied to the wiring Lc is supplied to the parasitic capacitance CPs[m] that is parasitic on the switch Ws[m] via two paths, that is, a path passing through the switch Wf and the resistor Rf and a path passing through the switch Wc[1] and the switch Ws[1], and the parasitic capacitance CPs[m] is charged.

As illustrated in FIG. 21, in the control period TT3 of the unit period TP(k) in which the high-speed charging process is executed, the coupling state designation signal Qc[1] maintains a low level, the coupling state designation signal Qs[1] maintains a high level, the coupling state designation signals Qc[2] to Qc[M] maintain a low level, the coupling state designation signals Qs[2] to Qs[M] maintain a low level, the coupling state designation signal Qf maintains a high level, the coupling state designation signal Q1 maintains a low level, and the coupling state designation signal Q2 maintains a high level. Therefore, as illustrated in FIG. 24, in the control period TT3 of the unit period TP(k), the switch Wc[1] maintains an OFF state, the switch Ws[1] maintains an ON state, the switches Wc[2] to Wc[M] maintain an OFF state, the switches Ws[2] to Ws[M] maintain an OFF state, the switch Wf maintains an ON state, the switch W1 maintains an OFF state, and the switch W2 maintains an ON state.

Therefore, in the control period TT3 of the unit period TP(k) in which the high-speed charging process is executed, the node Nd0 and the wiring Ls of the detection circuit 33 are electrically coupled to the wiring Lc via the switch Wf and the resistor Rf. In the control period TT3 of the unit period TP(k) in which the high-speed charging process is executed, the potential of the drive signal Com is the potential VS2. Therefore, in the control period TT3 of the unit period TP(k) in which the high-speed charging process is executed, the drive signal Com of the potential VS2 supplied to the wiring Lc is supplied to the parasitic capacitance CPs[m] that is parasitic on the switch Ws[m] via a path passing through the switch Wf and the resistor Rf, and the parasitic capacitance CPs[m] is charged.

In the control period TT3 of the unit period TP(k) in which the high-speed charging process is executed, the node Nd0 and the wiring Ls of the detection circuit 33 are electrically coupled to the upper electrode Zu[1] via the switch Ws[1]. Therefore, in the control period TT3 of the unit period TP(k) in which the high-speed charging process is executed, the potential of the node Nd0 is a potential based on the potential of the electrode potential signal VX[1], and the potential of the node Nd4 is a potential based on the potential of the node Nd0. In this case, the detection potential signal SL having a potential corresponding to the potential of the node Nd0 coupled to the wiring Ls is output from the node Nd4. In addition, in this case, the detection result signal SK[1] having a waveform corresponding to a potential change of the electrode potential signal VX[1] is output from the node Nd5.

As illustrated in FIG. 21, in the control period TT4 of the unit period TP(k) in which the high-speed charging process is executed, the coupling state designation signal Qc[1] maintains a low level, the coupling state designation signal Qs[1] maintains a high level, the coupling state designation signals Qc[2] to Qc[M] maintain a low level, the coupling state designation signals Qs[2] to Qs[M] maintain a low level, the coupling state designation signal Qf maintains a high level, the coupling state designation signal Q1 maintains a high level, and the coupling state designation signal Q2 maintains a low level. Therefore, as illustrated in FIG. 25, in the control period TT4 of the unit period TP(k), the switch Wc[1] maintains an OFF state, the switch Ws[1] maintains an ON state, the switches Wc[2] to Wc[M] maintain an OFF state, the switches Ws[2] to Ws[M] maintain an OFF state, the switch Wf maintains an ON state, the switch W1 maintains an ON state, and the switch W2 maintains an OFF state.

Therefore, in the control period TT4 of the unit period TP(k) in which the high-speed charging process is executed, the node Nd0 and the wiring Ls of the detection circuit 33 are electrically coupled to the wiring Lc via the switch Wf and the resistor Rf. In the control period TT4 of the unit period TP(k) in which the high-speed charging process is executed, the potential of the drive signal Com is the potential VS2. Therefore, in the control period TT4 of the unit period TP(k) in which the high-speed charging process is executed, the drive signal Com of the potential VS2 supplied to the wiring Lc is supplied to the parasitic capacitance CPs[m] that is parasitic on the switch Ws[m] via the path passing through the switch Wf and the resistor Rf, and the parasitic capacitance CPs[m] is charged.

As illustrated in FIG. 21, in the control period TT5 of the unit period TP(k) in which the high-speed charging process is executed, the coupling state designation signal Qc[1] maintains a low level, the coupling state designation signal Qs[1] maintains a low level, the coupling state designation signals Qc[2] to Qc[M] maintain a low level, the coupling state designation signals Qs[2] to Qs[M] maintain a low level, the coupling state designation signal Qf maintains a low level, the coupling state designation signal Q1 maintains a high level, and the coupling state designation signal Q2 maintains a low level. Therefore, as illustrated in FIG. 26, in the control period TT5 of the unit period TP(k), the switch Wc[1] maintains an OFF state, the switch Ws[1] maintains an OFF state, the switches Wc[2] to Wc[M] maintain an OFF state, the switches Ws[2] to Ws[M] maintain an OFF state, the switch Wf maintains an OFF state, the switch W1 maintains an ON state, and the switch W2 maintains an OFF state.

Therefore, in the control period TT5 of the unit period TP(k) in which the high-speed charging process is executed, the node Nd0 and the wiring Ls of the detection circuit 33 maintain a state in which the node Nd0 and the wiring Ls are not electrically coupled to the wiring Lc and the piezoelectric element PZ[m].

As described above, according to the present embodiment, in the high-speed charging process, the parasitic capacitance CPs[m] is charged via two paths, that is, a path passing through the switch Wf and the resistor Rf and a path passing through the switch Wc[1] and the switch Ws[1]. Therefore, according to the present embodiment, even when the parasitic capacitance CPs[m] is insufficiently charged by the low-speed charging process, the parasitic capacitance CPs[m] can be reliably charged by the high-speed charging process.

Further, according to the present embodiment, charging is performed on the parasitic capacitance CPs[m] by the low-speed charging process, and then charging is performed on the parasitic capacitance CPs[m] by the high-speed charging process. Therefore, according to the present embodiment, in the high-speed charging process, the possibility that a current equal to or greater than the maximum rated current flows through the switch Wc[m], the switch Ws[m], and the switch Wf can be suppressed as compared with an aspect (hereinafter, referred to as “comparative example”) in which the high-speed charging process is performed without performing the low-speed charging process. Therefore, according to the present embodiment, a risk in which the switch Wc[m], the switch Ws[m], and the switch Wf fail in the high-speed charging process can be reduced.

### 7. Outline of Inspection Process

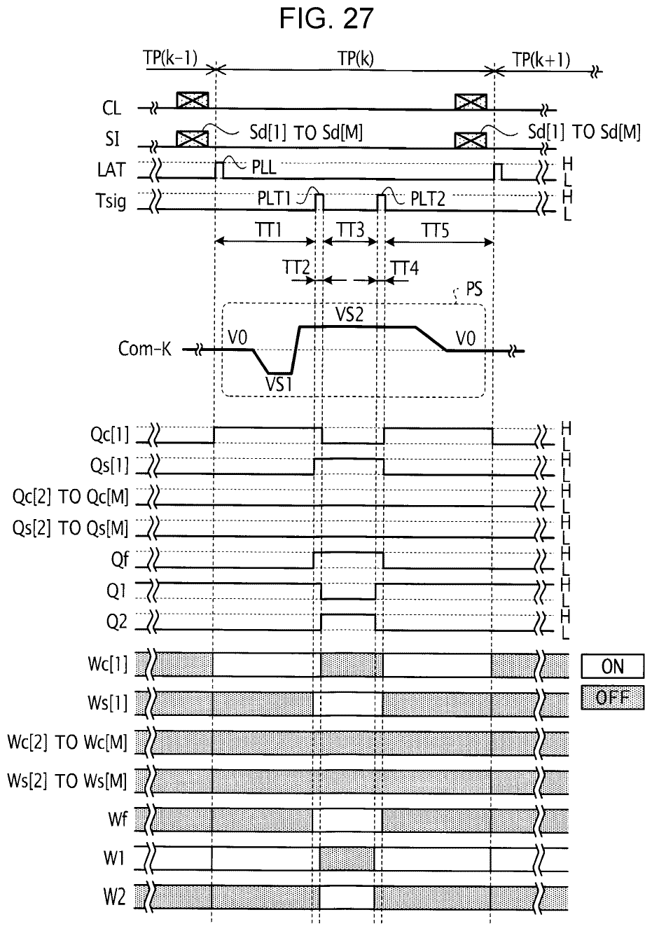

Hereinafter, an outline of the inspection process will be described with reference to FIGS. 27 to 33.

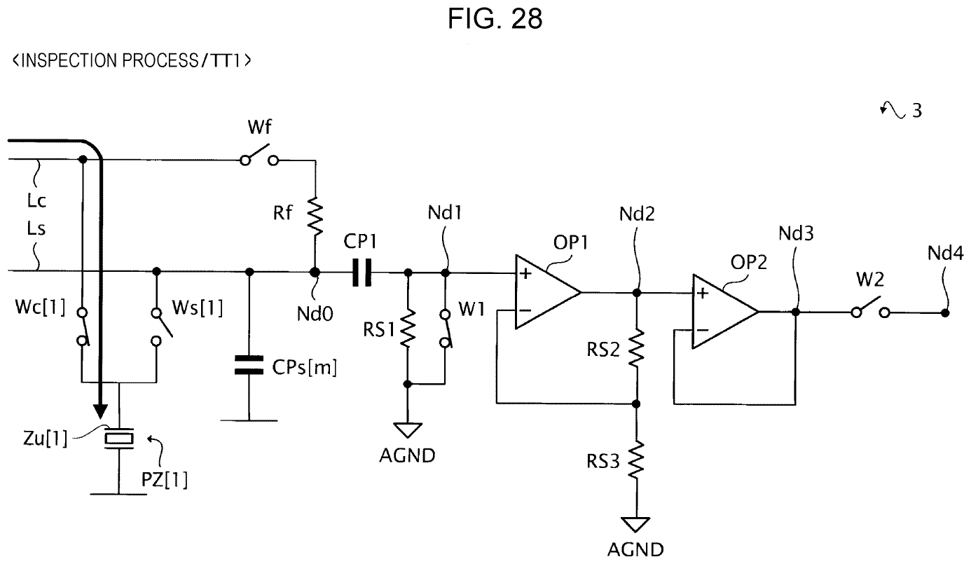

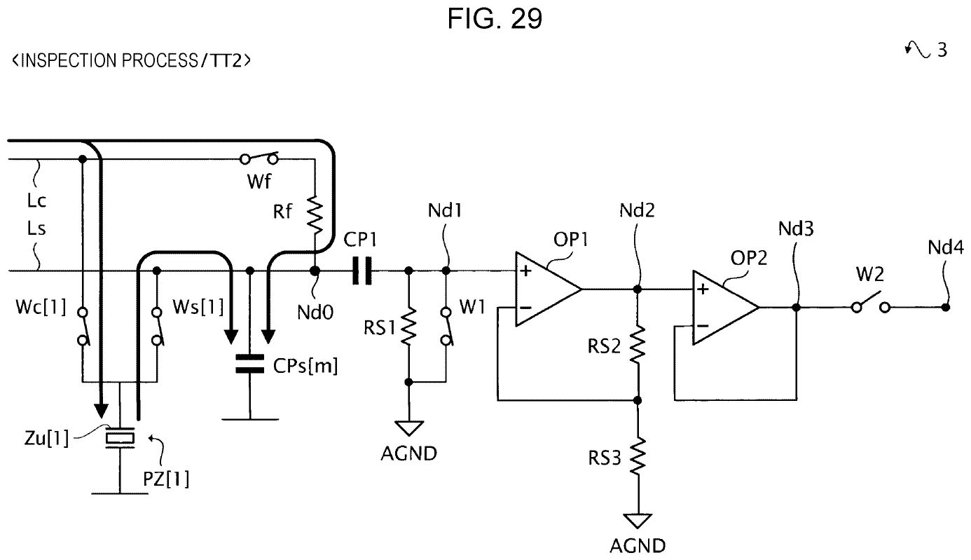

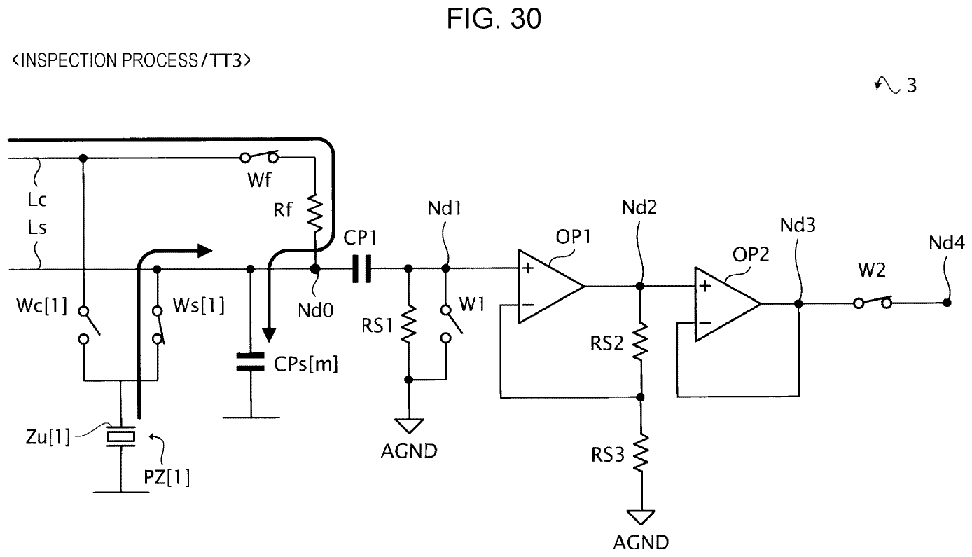

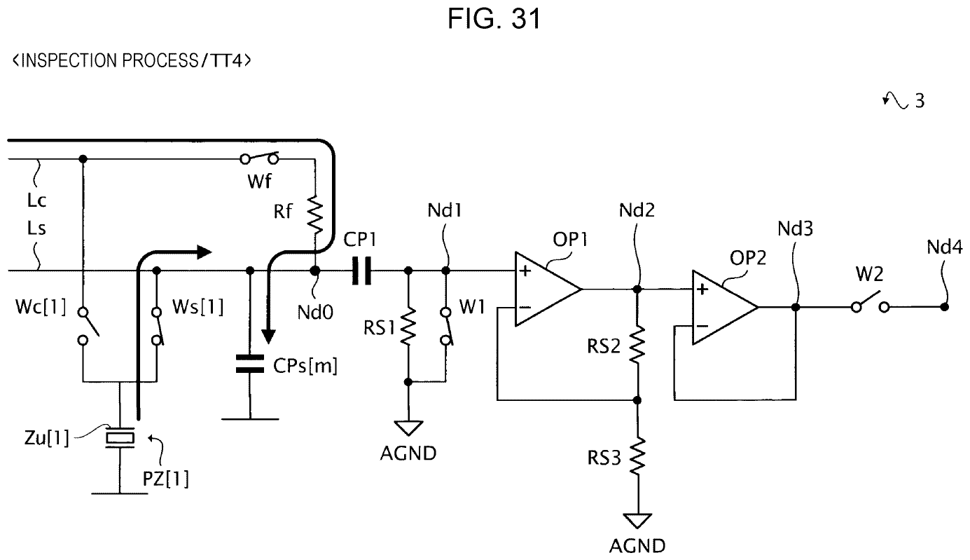

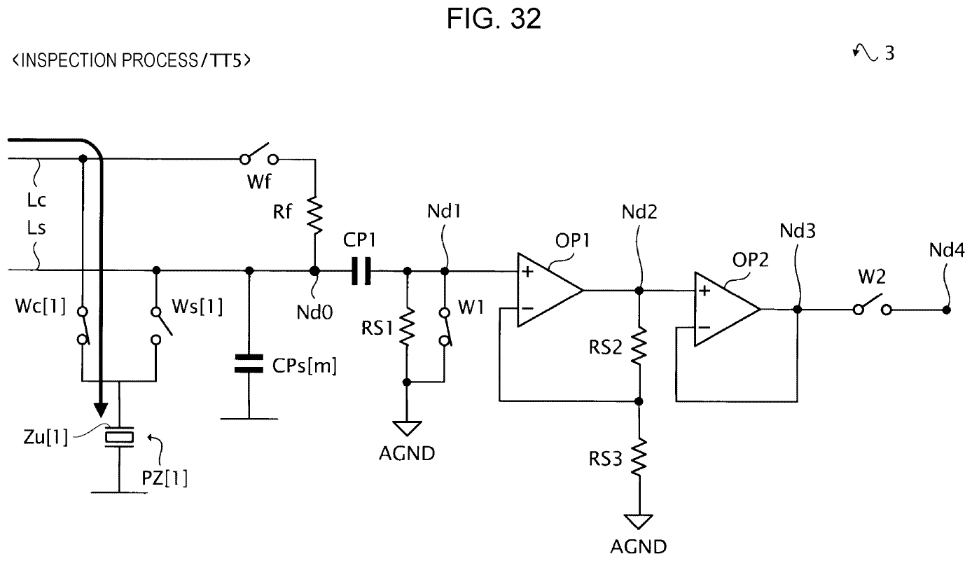

FIG. 27 is a timing chart for explaining an example of the operation of the head unit 3 when the inspection process is executed in the ink jet printer 1. Further, FIGS. 28 to 32 are circuit diagrams for explaining an example of the operation of the head unit 3 when the inspection process is executed in the ink jet printer 1. Specifically, FIG. 28 is a diagram illustrating an example of the operation of the head unit 3 in the control period TT1 of the unit period TP(k) in which the inspection process is executed, FIG. 29 is a diagram illustrating an example of the operation of the head unit 3 in the control period TT2 of the unit period TP(k) in which the inspection process is executed, FIG. 30 is a diagram illustrating an example of the operation of the head unit 3 in the control period TT3 of the unit period TP(k) in which the inspection process is executed, FIG. 31 is a diagram illustrating an example of the operation of the head unit 3 in the control period TT4 of the unit period TP(k) in which the inspection process is executed, FIG. 32 is a diagram illustrating an example of the operation of the head unit 3 in the control period TT5 of the unit period TP(k) in which the inspection process is executed. Note that in FIGS. 28 to 32, a case where the ejection portion D[1] is designated as the inspection target ejection portion DK and the ejection portions D[2] to D[M] are designated as the standby ejection portions DT is assumed as an example.

As illustrated in FIG. 27, in the control period TT1 of the unit period TP(k) in which the inspection process is executed, the coupling state designation signal Qc[1] maintains a high level, the coupling state designation signal Qs[1] maintains a low level, the coupling state designation signals Qc[2] to Qc[M] maintain a low level, the coupling state designation signals Qs[2] to Qs[M] maintain a low level, the coupling state designation signal Qf maintains a low level, the coupling state designation signal Q1 maintains a high level, and the coupling state designation signal Q2 maintains a low level. Therefore, as illustrated in FIG. 28, in the control period TT1 of the unit period TP(k), the switch Wc[1] maintains an ON state, the switch Ws[1] maintains an OFF state, the switches Wc[2] to Wc[M] maintain an OFF state, the switches Ws[2] to Ws[M] maintain an OFF state, the switch Wf maintains an OFF state, the switch W1 maintains an ON state, and the switch W2 maintains an OFF state.

Therefore, in the control period TT1 of the unit period TP(k) in which the inspection process is executed, the drive signal Com is supplied from the wiring Lc to the upper electrode Zu[1] via the switch Wc[1], and as a result, the piezoelectric element PZ[1] is driven and the ejection portion D[1] vibrates.

As illustrated in FIG. 27, in the control period TT2 of the unit period TP(k) in which the inspection process is executed, the coupling state designation signal Qc[1] maintains a high level, the coupling state designation signal Qs[1] maintains a high level, the coupling state designation signals Qc[2] to Qc[M] maintain a low level, the coupling state designation signals Qs[2] to Qs[M] maintain a low level, the coupling state designation signal Qf maintains a high level, the coupling state designation signal Q1 maintains a high level, and the coupling state designation signal Q2 maintains a low level. Therefore, as illustrated in FIG. 29, in the control period TT2 of the unit period TP(k), the switch Wc[1] maintains an ON state, the switch Ws[1] maintains an ON state, the switches Wc[2] to Wc[M] maintain an OFF state, the switches Ws[2] to Ws[M] maintain an OFF state, the switch Wf maintains an ON state, the switch W1 maintains an ON state, and the switch W2 maintains an OFF state.

Therefore, in the control period TT2 of the unit period TP(k) in which the inspection process is executed, the node Nd0 and the wiring Ls of the detection circuit 33 are electrically coupled to the wiring Lc via the switch Wf and the resistor Rf. In the control period TT2 of the unit period TP(k) in which the inspection process is executed, the node Nd0 and the wiring Ls of the detection circuit 33 are electrically coupled to the wiring Lc via the switch Wc[1] and the switch Ws[1]. In the control period TT2 of the unit period TP(k) in which the inspection process is executed, the potential of the drive signal Com is the potential VS2. Therefore, in the control period TT2 of the unit period TP(k) in which the inspection process is executed, the drive signal Com of the potential VS2 supplied to the wiring Lc is supplied to the parasitic capacitance CPs[m] that is parasitic on the switch Ws[m] via two paths, that is, a path passing through the switch Wf and the resistor Rf and a path passing through the switch Wc[1] and the switch Ws[1], and the parasitic capacitance CPs[m] is charged.

Note that the vibration generated in the ejection portion D[1] in the control period TT1 of the unit period TP(k) in which the inspection process is executed also remains in the control period TT2 of the unit period TP(k). Then, in the control period TT2 of the unit period TP(k) in which the inspection process is executed, the potential of the upper electrode Zu[1] changes due to the vibration remaining in the ejection portion D[1]. Then, in the control period TT2 of the unit period TP(k) in which the inspection process is executed, the potential of the upper electrode Zu[1] is supplied to the node Nd0 via the switch Ws[1] as the electrode potential signal VX[1].

As illustrated in FIG. 27, in the control period TT3 of the unit period TP(k) in which the inspection process is executed, the coupling state designation signal Qc[1] maintains a low level, the coupling state designation signal Qs[1] maintains a high level, the coupling state designation signals Qc[2] to Qc[M] maintain a low level, the coupling state designation signals Qs[2] to Qs[M] maintain a low level, the coupling state designation signal Qf maintains a high level, the coupling state designation signal Q1 maintains a low level, and the coupling state designation signal Q2 maintains a high level. Therefore, as illustrated in FIG. 30, in the control period TT3 of the unit period TP(k), the switch Wc[1] maintains an OFF state, the switch Ws[1] maintains an ON state, the switches Wc[2] to Wc[M] maintain an OFF state, the switches Ws[2] to Ws[M] maintain an OFF state, the switch Wf maintains an ON state, the switch W1 maintains an OFF state, and the switch W2 maintains an ON state.

Therefore, in the control period TT3 of the unit period TP(k) in which the inspection process is executed, the node Nd0 and the wiring Ls of the detection circuit 33 are electrically coupled to the wiring Lc via the switch Wf and the resistor Rf. In the control period TT3 of the unit period TP(k) in which the inspection process is executed, the potential of the drive signal Com is the potential VS2. Therefore, in the control period TT3 of the unit period TP(k) in which the inspection process is executed, the drive signal Com of the potential VS2 supplied to the wiring Lc is supplied to the parasitic capacitance CPs[m] that is parasitic on the switch Ws[m] via the path passing through the switch Wf and the resistor Rf, and the parasitic capacitance CPs[m] is charged.

In the control period TT3 of the unit period TP(k) in which the inspection process is executed, the node Nd0 and the wiring Ls of the detection circuit 33 are electrically coupled to the upper electrode Zu[1] via the switch Ws[1]. Therefore, in the control period TT3 of the unit period TP(k) in which the inspection process is executed, the potential of the node Nd0 is a potential based on the potential of the electrode potential signal VX[1], and the potential of the node Nd4 is a potential based on the potential of the node Nd0. In this case, the detection potential signal SL having a potential corresponding to the potential of the node Nd0 coupled to the wiring Ls is output from the node Nd4. In addition, in this case, the detection result signal SK[1] having a waveform corresponding to a potential change of the electrode potential signal VX[1] is output from the node Nd5.

As illustrated in FIG. 27, in the control period TT4 of the unit period TP(k) in which the inspection process is executed, the coupling state designation signal Qc[1] maintains a low level, the coupling state designation signal Qs[1] maintains a high level, the coupling state designation signals Qc[2] to Qc[M] maintain a low level, the coupling state designation signals Qs[2] to Qs[M] maintain a low level, the coupling state designation signal Qf maintains a high level, the coupling state designation signal Q1 maintains a high level, and the coupling state designation signal Q2 maintains a low level. Therefore, as illustrated in FIG. 31, in the control period TT4 of the unit period TP(k), the switch Wc[1] maintains an OFF state, the switch Ws[1] maintains an ON state, the switches Wc[2] to Wc[M] maintain an OFF state, the switches Ws[2] to Ws[M] maintain an OFF state, the switch Wf maintains an ON state, the switch W1 maintains an ON state, and the switch W2 maintains an OFF state.

Therefore, in the control period TT4 of the unit period TP(k) in which the inspection process is executed, the node Nd0 and the wiring Ls of the detection circuit 33 are electrically coupled to the wiring Lc via the switch Wf and the resistor Rf. In the control period TT4 of the unit period TP(k) in which the inspection process is executed, the potential of the drive signal Com is the potential VS2. Therefore, in the control period TT4 of the unit period TP(k) in which the inspection process is executed, the drive signal Com of the potential VS2 supplied to the wiring Lc is supplied to the parasitic capacitance CPs[m] that is parasitic on the switch Ws[m] via the path passing through the switch Wf and the resistor Rf, and the parasitic capacitance CPs[m] is charged.

As illustrated in FIG. 27, in the control period TT5 of the unit period TP(k) in which the inspection process is executed, the coupling state designation signal Qc[1] maintains a high level, the coupling state designation signal Qs[1] maintains a low level, the coupling state designation signals Qc[2] to Qc[M] maintain a low level, the coupling state designation signals Qs[2] to Qs[M] maintain a low level, the coupling state designation signal Qf maintains a low level, the coupling state designation signal Q1 maintains a high level, and the coupling state designation signal Q2 maintains a low level. Therefore, as illustrated in FIG. 32, in the control period TT5 of the unit period TP(k), the switch Wc[1] maintains an ON state, the switch Ws[1] maintains an OFF state, the switches Wc[2] to Wc[M] maintain an OFF state, the switches Ws[2] to Ws[M] maintain an OFF state, the switch Wf maintains an OFF state, the switch W1 maintains an ON state, and the switch W2 maintains an OFF state.

Therefore, in the control period TT5 of the unit period TP(k) in which the inspection process is executed, the drive signal Com is supplied from the wiring Lc to the upper electrode Zu[1] via the switch Wc[1], and as a result, the piezoelectric element PZ[1] is driven.

As described above, according to the present embodiment, the detection result signal SK[1] having a waveform corresponding to a potential change of the electrode potential signal VX[1] is output from the node Nd5 in the control period TT3 of the unit period TP(k) in which the inspection process is executed. According to the present embodiment, in the control period TT3 of the unit period TP(k) in which the inspection process is executed, since the parasitic capacitance CPs[m] is sufficiently charged in the previously executed charging process, occurrence of a situation in which a current of the electrode potential signal VX[1] is used for charging the parasitic capacitance CPs[m] can be suppressed. Therefore, according to the present embodiment, the detection circuit 33 can output the detection result signal SK[1] accurately representing the waveform based on a vibration remaining in the ejection portion D[1] in the control period TT3 of the unit period TP(k) in which the inspection process is executed.

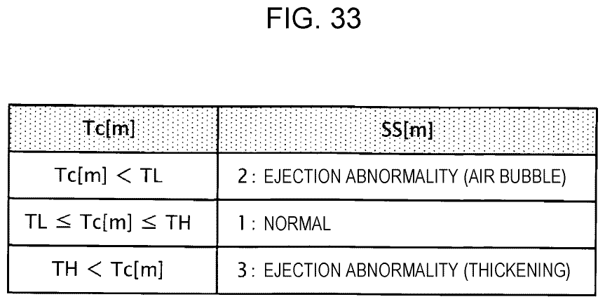

FIG. 33 is an explanatory view for explaining an example of the operation of the inspection unit 5 in the inspection process.

The inspection unit 5 inspects whether an ink ejection state of the ejection portion D[m] is normal, that is, whether the ejection portion D[m] is in a normal ejection state in which ejection abnormality does not occur based on the detection result signal SK[m], and outputs an inspection result signal SS[m] indicating the result of the inspection. Here, the ejection abnormality is a general term for a state in which the ink ejection state in the ejection portion D[m] is abnormal, that is, a state in which the ink cannot be accurately ejected from the nozzle N included in the ejection portion D[m]. For example, the ejection abnormality includes a state in which the ink cannot be ejected from the ejection portion D[m], a state in which the ejection portion D[m] ejects the ink in an amount different from an ink ejection amount defined by the drive signal Com, a state in which the ejection portion D[m] ejects the ink at a speed different from an ink ejection speed defined by the drive signal Com, or the like.

In general, the vibration remaining in the ejection portion D[m] has a natural vibration cycle determined by a shape of the nozzle N of the ejection portion D[m], a weight of the ink filled in the cavity CV[m] of the ejection portion D[m], a viscosity of the ink filled in the cavity CV[m] of the ejection portion D[m], and the like. Then, in general, when the ejection abnormality occurs due to air bubbles mixed in the cavity CV[m] of the ejection portion D[m], a cycle of the vibration remaining in the ejection portion D[m] is shorter as compared with a case where the ejection state is normal. Further, in general, when an ejection abnormality occurs due to foreign matters such as paper dust adhering to the vicinity of the nozzle N of the ejection portion D[m], the cycle of the vibration remaining in the ejection portion D[m] is longer as compared with a case where the ejection state is normal. Further, in general, when an ejection abnormality occurs due to the increased viscosity of the ink in the cavity CV[m] of the ejection portion D[m], the cycle of the vibration remaining in the ejection portion D[m] is longer as compared with a case where the ejection state is normal. As described above, the cycle of the vibration remaining in the ejection portion D[m] fluctuates depending on the ink ejection state in the ejection portion D[m]. Therefore, the ink ejection state in the ejection portion D[m] can be inspected based on the cycle of the vibration remaining in the ejection portion D[m].

As described above, the waveform of the detection result signal SK[m] indicates a waveform of the vibration remaining in the ejection portion D[m] driven as the inspection target ejection portion DK. That is, the cycle TC[m] of the waveform of the detection result signal SK[m] is a cycle of the vibration remaining in the ejection portion D[m] driven as the inspection target ejection portion DK. Therefore, the ink ejection state of the ejection portion D[m] driven as the inspection target ejection portion DK can be inspected based on the cycle TC[m] of the waveform of the detection result signal SK[m].

In the present embodiment, the inspection unit 5 designates the cycle TC[m] of the waveform of the detection result signal SK[m] based on the detection result signal SK[m]. As illustrated in FIG. 33, the inspection unit 5 inspects the ink ejection state of the ejection portion D[m] driven as the inspection target ejection portion DK by comparing the cycle TC[m] with one or both of a threshold value TL and a threshold value TH, and generates an inspection result signal SS[m] indicating the result of the inspection. Here, the threshold value TL is an estimated value of a boundary between a cycle TC[m] of the vibration generated in the ejection portion D[m] when the ejection state of the ejection portion D[m] is normal and a cycle TC[m] of the vibration generated in the ejection portion D[m] when air bubbles are mixed in the cavity CV[m] of the ejection portion D[m]. In addition, the threshold value TH is a value larger than the threshold value TL, and is an estimated value of the boundary between the cycle TC[m] of the vibration generated in the ejection portion D[m] when the ejection state of the ejection portion D[m] is normal and the cycle TC[m] of the vibration generated in the ejection portion D[m] when foreign matters adhere to the vicinity of the nozzle N of the ejection portion D[m] or when the ink in the cavity CV[m] of the ejection portion D[m] is thickened.

As illustrated in FIG. 33, when the cycle TC[m] satisfies “TL≤TC[m]≤TH”, the inspection unit 5 considers that the ink ejection state of the ejection portion D[m] is normal, and sets a value “1” indicating that the ink ejection state of the ejection portion D[m] is normal for the inspection result signal SS[m]. Further, when the cycle TC[m] satisfies “TC[m]<TL”, the inspection unit 5 considers that the ejection abnormality occurs because air bubbles are mixed in the cavity CV[m] of the ejection portion D[m], and sets a value “2” indicating that the ejection abnormality occurs due to the air bubbles in the ejection portion D[m] for the inspection result signal SS[m]. Further, when the cycle TC[m] satisfies “TH<TC[m]”, the inspection unit 5 considers that the ejection abnormality occurs due to the fact that foreign matters such as paper dust adhere to the nozzle N of the ejection portion D[m] or the ink in the cavity CV[m] of the ejection portion D[m] is thickened, and sets a value “3” indicating that the ejection abnormality due to the foreign matters or the thickening occurs in the ejection portion D[m] for the inspection result signal SS[m]. As described above, the inspection unit 5 generates the inspection result signal SS[m] based on the cycle TC[m] of the waveform of the detection result signal SK[m].

### 8. Summary of Present Embodiment

As described above, according to the present embodiment, in the low-speed charging process, the parasitic capacitance CPs[m] is charged via the resistor Rf having a sufficiently large resistance value. Therefore, according to the present embodiment, in the low-speed charging process, the risk in which the switch Wc[m], the switch Ws[m], and the switch Wf fail can be suppressed.

Further, according to the present embodiment, when the parasitic capacitance CPs[m] cannot be sufficiently charged by executing the low-speed charging process in the unit period TP(k), the low-speed charging process is repeatedly executed in the unit period TP(k+1). Therefore, according to the present embodiment, occurrence of a situation in which the charging of the parasitic capacitance CPs[m] is insufficient can be suppressed.

Further, according to the present embodiment, in the high-speed charging process, the parasitic capacitance CPs[m] is charged via two paths, that is, a path passing through the switch Wf and the resistor Rf and a path passing through the switch Wc[1] and the switch Ws[1]. Therefore, according to the present embodiment, the parasitic capacitance CPs[m] can be reliably charged by the high-speed charging process.

Further, according to the present embodiment, charging is performed on the parasitic capacitance CPs[m] by the low-speed charging process, and then charging is performed on the parasitic capacitance CPs[m] by the high-speed charging process. Therefore, according to the present embodiment, a risk in which the switch Wc[m], the switch Ws[m], and the switch Wf fail in the high-speed charging process can be reduced.

Further, according to the present embodiment, in the control period TT3 of the unit period TP(k) in which the inspection process is executed, occurrence of a situation in which the current of the electrode potential signal VX[m] is used for charging the parasitic capacitance CPs can be suppressed. Therefore, according to the present embodiment, the detection circuit 33 can output the detection result signal SK[m] accurately representing the waveform based on the vibration remaining in the ejection portion D[m] in the control period TT3 of the unit period TP(k) in which the inspection process is executed.

### B. Modification Examples

Each aspect described above can be variously modified. A specific aspect of the modification will be described below. Two or more aspects selected in any manner from the following examples can be combined with each other as appropriate within a range not inconsistent with each other. In addition, in the modification examples illustrated below, elements whose operations or functions are the same as those of the embodiments will be designated by the same reference numerals as those used in the above description, and the detailed description of each of the elements will be appropriately omitted.

### Modification Example 1

In the above-described embodiment, a case where the detection potential signal SL is a signal indicating the potential of the node Nd4 is described as an example, but the present disclosure is not limited to such an aspect. The detection potential signal SL may be a signal indicating a potential at any position of the detection circuit 33. For example, the detection potential signal SL may be a signal indicating a potential of the node Nd0, or may be a signal indicating a potential of the node Nd5.

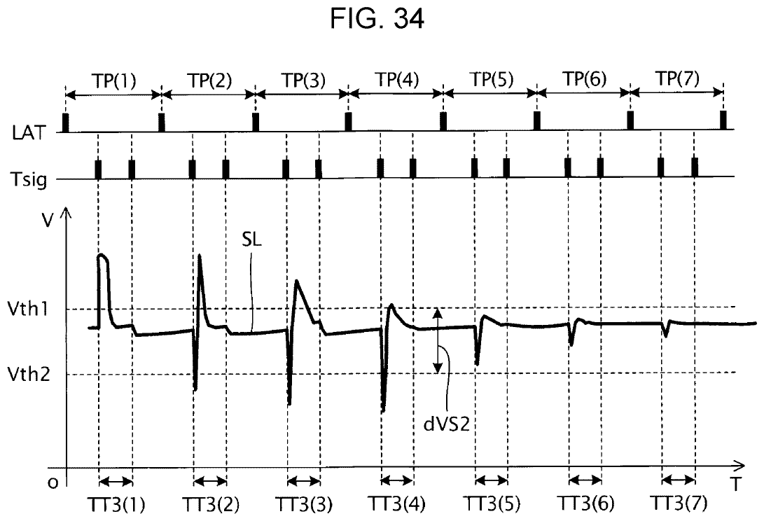

FIG. 34 is an explanatory view for explaining a potential change of the detection potential signal SL in the non-print process according to the present modification example. Note that in the present modification example, a case where the detection potential signal SL is a signal indicating a potential of the node Nd5 will be described as an example. The ink jet printer 1 according to the present modification example has the same configuration as in the ink jet printer 1 according to the embodiment except that the detection potential signal SL is a signal indicating the potential of the node Nd5. Further, in FIG. 34, it is assumed that the low-speed charging process is repeatedly executed until a specific condition is satisfied in seven unit periods TP(1) to TP(7). Then, it is assumed that the capacitance that is parasitic on the switch Ws[m] is not charged at the start point of the unit period TP(1).

As illustrated in FIG. 34, when the non-print process is started and the low-speed charging process is executed in the unit period TP(1), since the charging of the capacitance that is parasitic on the switch Ws[m] is not completed, the potential of the detection potential signal SL fluctuates greatly from a potential equal to or lower than an upper threshold potential Vth1 to a potential higher than the upper threshold potential Vth1. Similarly, even in the unit period TP(3), and the unit period TP(4), since the potential of the detection potential signal SL is in a state in which the charging of the capacitance that is parasitic on the switch Ws[m] is not completed in the unit period TP(2), the potential of the detection potential signal SL fluctuates greatly from a potential lower than a lower threshold potential Vth2 to a potential higher than the upper threshold potential Vth1.

Thereafter, in the unit periods TP(5) to TP(7), the charging of the capacitance that is parasitic on the switch Ws[m] progresses, a maximum potential of the detection potential signal SL becomes a potential equal to or lower than the upper threshold potential Vth1, and a minimum potential of the detection potential signal SL becomes a potential equal to or higher than the lower threshold potential Vth2. That is, in the unit periods TP(5) to TP(7), a fluctuation width of the potential of the detection potential signal SL is equal to or less than an allowable fluctuation amount dVS2 and is smaller than a fluctuation width in the unit periods TP(1) to TP(4). Here, the allowable fluctuation amount dVS2 is a value obtained by subtracting the lower threshold potential Vth2 from the upper threshold potential Vth1. The allowable fluctuation amount dVS2 may be, for example, a potential fluctuation amount of the node Nd5 corresponding to a case where the maximum rated current flows through the switch Ws[m]. In addition, in the present modification example, a condition that a highest potential of the detection potential signal SL in the unit period TP(k) is a potential equal to or lower than the upper threshold potential Vth1 and a lowest potential of the detection potential signal SL in the unit period TP(k) is a potential equal to or higher than the lower threshold potential Vth2 is adopted as a specific condition. In the example illustrated in FIG. 34, the specific condition is satisfied in the unit period TP(5). However, in the present modification example, a condition that the potential fluctuation amount of the detection potential signal SL in the unit period TP(k) is equal to or less than the allowable fluctuation amount dVS2 may be adopted as a specific condition.

As described above, according to the present modification example, the parasitic capacitance CPs[m] is charged by the low-speed charging process, and whether or not to repeat the low-speed charging process is determined based on the detection potential signal SL. Therefore, according to the present modification example, in the charging process, the risk in which the switch Wc[m], the switch Ws[m], and the switch Wf fail can be reduced, and occurrence of a situation in which the parasitic capacitance CPs[m] is insufficiently charged can be suppressed.

Note that in the present modification example, the allowable fluctuation amount dVS2 is an example of a “predetermined amount”, the upper threshold potential Vth1 is an example of a “first threshold value”, the lower threshold potential Vth2 is an example of a “second threshold value”, and the condition that the detection potential signal SL maintains a potential equal to or lower than the upper threshold potential Vth1 in the unit period TP(k) is an example of a “first condition”, and the condition that the detection potential signal SL maintains a potential equal to or higher than the lower threshold potential Vth2 in the unit period TP(k) is an example of a “second condition”.

### Modification Example 2

In the above-described embodiment and Modification Example 1, a case where the charging process is a process including one or a plurality of low-speed charging processes and a high-speed charging process performed after the one or plurality of low-speed charging processes is described as an example, but the present disclosure is not limited to such an aspect. The charging process may be a process including at least one or a plurality of low-speed charging processes.

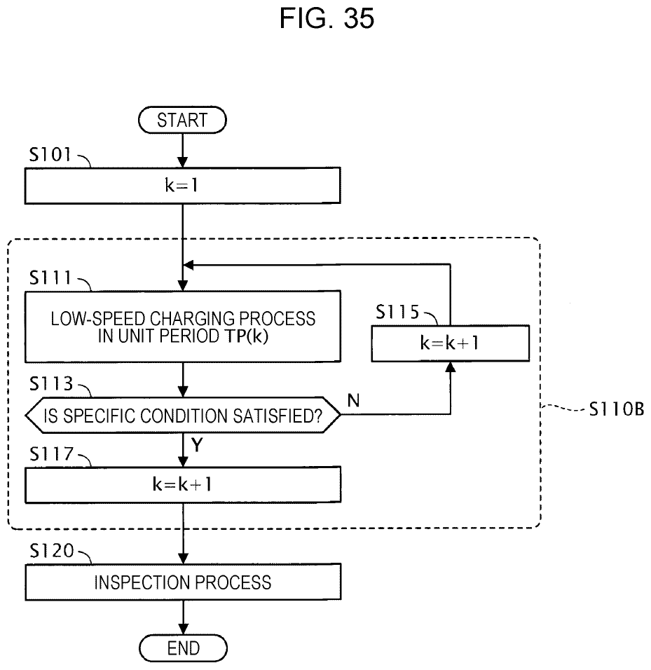

FIG. 35 is a flowchart illustrating an example of the operation of the ink jet printer 1 when the non-print process is executed according to the present modification example. Note that in the present modification example, it is assumed that the non-print process is a process including the low-speed charging process and the inspection process.

As illustrated in FIG. 35, when the non-print process is initiated, the control unit 2 sets the variable k to “1” (S101).

Next, the ink jet printer 1 executes the charging process according to the present modification example (S110B).

Specifically, first, the ink jet printer 1 executes the low-speed charging process as the charging process in the unit period TP(k) (S111).

Next, the determination unit 6 provided in the ink jet printer 1 determines whether or not the detection potential signal SL satisfies a specific condition as the charging process (S113).

Then, when the result of the determination in Step S113 is negative, the ink jet printer 1 adds “1” to the variable k (S115), and the process proceeds to Step S111.

On the other hand, when the result of the determination in step S113 is positive, the ink jet printer 1 adds “1” to the variable k (S117), terminates the charging process, and proceeds the process to step S120.

Thereafter, the ink jet printer 1 executes the inspection process in the unit period TP(k) (S120) and terminates the non-print process.

As described above, according to the present modification example, the parasitic capacitance CPs[m] is charged by the low-speed charging process, and whether or not the low-speed charging process needs to be repeated is determined based on the detection potential signal SL as in the embodiment. Therefore, according to the present modification example, in the charging process, the risk in which the switch Wc[m], the switch Ws[m], and the switch Wf fail can be reduced, and occurrence of a situation in which the parasitic capacitance CPs[m] is insufficiently charged can be suppressed.

### Modification Example 3

In the above-described embodiment and Modification Examples 1 and 2, the aspect in which the determination unit 6 determines termination of the low-speed charging process based on the detection potential signal SL is described as an example, but the present disclosure is not limited to such an aspect. Termination of the low-speed charging process may be determined based on information on the number of times of charging stored in the storage unit 8. Here, information on the number of times of charging is the number of times of execution of the low-speed charging process (hereinafter, referred to as “required number of times of charging”. An example of “first number of times”) required for charging the parasitic capacitance CPs[m] and satisfying a specific condition.

In the present modification example, when the storage unit 8 does not store the information on the number of times of charging, the control unit 2 executes the non-print process illustrated in FIG. 13 or FIG. 35. In the present modification example, the control unit 2 determines the required number of times of charging based on the execution result of the non-print process illustrated in FIG. 13 or FIG. 35, and stores the information on the number of times of charging indicating the required number of times of charging in the storage unit 8. Specifically, in the present modification example, the control unit 2 determines the number of times of the low-speed charging process executed in the non-print process illustrated in FIG. 13 or FIG. 35 as the required number of times of charging, and stores information on the number of times of charging indicating the required number of times of charging in the storage unit 8. Note that in the present modification example, the information on the number of times of charging may be generated in advance before the ink jet printer 1 is shipped.

On the other hand, in the present modification example, when the storage unit 8 stores the required number of times of charging, the control unit 2 repeats the low-speed charging process by the required number of times of charging which is indicated by the information on the number of times of charging in the non-print process. In this case, the determination unit 6 may not execute a specific condition determination process.

### Modification Example 4

In the above-described embodiment and Modification Examples 1 to 3, an aspect in which the coupling state designation circuit 310 generates the coupling state designation signal Qf, the coupling state designation signal Q1, and the coupling state designation signal Q2 based on the mode signal Mod is described as an example, but the present disclosure is not limited to such an aspect. The coupling state designation circuit 310 may generate the coupling state designation signal Qf, the coupling state designation signal Q1, and the coupling state designation signal Q2 based on the designation signal SI. In this case, the control unit 2 may not supply the mode signal Mod to the head unit 3.

For example, when the designation signal SI includes the individual designation signal Sd[m] indicating any of “1”, “2”, “3”, and “4”, the coupling state designation circuit 310 considers that the print process is being executed, maintains the coupling state designation signal Qf at a low level over the unit period TP(k), maintains the coupling state designation signal Q1 at a high level over the unit period TP(k), and maintains the coupling state designation signal Q2 at a low level over the unit period TP(k). For example, when the designation signal SI includes the individual designation signal Sd[m] indicating any of “5”, “6”, and “7”, the coupling state designation circuit 310 considers that the non-print process is being executed, and maintains the coupling state designation signal Qf at a high level in the control period TT2, the control period TT3, and the control period TT4, maintains the coupling state designation signal Q1 at a high level in the control period TT1, the control period TT2, the control period TT4, and the control period TT5, and maintains the coupling state designation signal Q2 at a high level in the control period TT3.

### Modification Example 5

In the above-described embodiment and Modification Examples 1 to 4, a case where the detection circuit 33 includes the front-stage detection circuit 331 and the rear-stage detection circuit 332 is described as an example, but the present disclosure is not limited to such an aspect. The detection circuit 33 may include at least the front-stage detection circuit 331. In this case, the rear-stage detection circuit 332 may be provided in the inspection unit 5.

### Modification Example 6

Although it is assumed that when the ink jet printer 1 includes four head units 3 in the above-described embodiment and Modification Examples 1 to 5, the present disclosure is not limited to such an aspect. The ink jet printer 1 may include one or more head units 3 and three or less head units 3, or may include five or more head units 3.

### Modification Example 7

In the above-described embodiments and Modification Examples 1 to 6, the ink jet printer 1 is illustrated as a serial printer, but the present disclosure is not limited to such a mode. The ink jet printer 1 may be a so-called line printer in which a plurality of nozzles N are provided in the head unit 3 to extend wider than the width of the recording paper PP.

### C. Additional Notes

Aspects related to the above embodiments and modification examples are additionally noted below. Note that in order to facilitate understanding of each aspect, the following description will be made with reference to the accompanying drawings, but the present disclosure is not limited to the illustrated aspect.

### Additional Note 1

According to Additional Note 1, there is provided an ink jet printer including an ejection portion D[m] that includes a piezoelectric element PZ[m] driven by a drive signal Com supplied to an upper electrode Zu[m] via a wiring Lc and ejects ink in correspondence with the drive of the upper electrode Zu[m], a detection circuit 33 that detects a potential of the upper electrode Zu[m] via a wiring Ls, an inspection unit 5 that inspects the ejection portion D[m] based on a detection result of the detection circuit 33, a switch Wc[m] that switches whether or not to electrically couple the wiring Lc and the upper electrode Zu[m], a switch Ws[m] that switches whether or not to electrically couple the wiring Ls and the upper electrode Zu[m], a switch Wf that switches whether or not to electrically couple the wiring Lc and the wiring Ls, and a coupling state designation circuit 310 that designates an electrical coupling state of the switch Wf, in which the coupling state designation circuit 310 executes a first charging operation of designating the coupling state of the switch Wf such that a low-speed charging process in which the switch Wf enters an ON state is executed in at least one period of a preparation period including one or a plurality of unit periods TP(k) before inspection of the ejection portion D[m] by the inspection unit 5, terminates the first charging operation when a detection potential signal SL corresponding to a potential detected by the detection circuit 33 satisfies a specific condition, and continues the first charging operation when the detection potential signal SL does not satisfy the specific condition.

According to Additional Note 1, since termination of the first charging operation is determined based on the detection potential signal SL corresponding to the potential detected by the detection circuit 33, occurrence of overcharging or insufficient charging of the parasitic capacitance CPs[m] that is parasitic on the switch Ws[m] can be suppressed.

### Additional Note 2

According to Additional Note 2, the ink jet printer 1 according to Additional Note 1 further includes a resistor Rf provided between the switch Wf and the wiring Ls or between the wiring Lc and the switch Wf.

According to the Additional Note 2, since the parasitic capacitance CPs[m] is charged via the resistor Rf, the failure of the switch Wf at the time of charging the parasitic capacitance CPs[m] can be suppressed.

### Additional Note 3

According to Additional Note 3, in the ink jet printer 1 according to Additional Note 1 or 2, the coupling state designation circuit 310 designates the electrical coupling state of the switch Wc[m] and the switch Ws[m], and executes a second charging operation of designating the coupling state of the switch Wc[m], the switch Ws[m], and the switch Wf such that a high-speed charging process in which the switch Wc[m], the switch Ws[m], and the switch Wf enter an ON state is executed in at least a part of a period after termination of the first charging operation in the preparation period when the detection potential signal SL satisfies the specific condition.

According to Additional Note 3, since the low-speed charging process is executed before the high-speed charging process, as compared with an aspect in which the high-speed charging process is performed without performing the low-speed charging process, occurrence of a situation in which the amount of current for charging the parasitic capacitance CPs[m] is increased at the start of the high-speed charging process can be suppressed. Therefore, according to Additional Note 3, the possibility that the switch Wc[m] and the switch Ws[m] fail due to the increase in the amount of current at the start of the high-speed charging process can be reduced.

### Additional Note 4

According to Additional Note 4, the ink jet printer 1 according to any one of Additional Notes 1 to 3 further includes a storage unit 8 that stores information on the number of times of charging, in which the drive signal Com is a signal having the waveform PS repeated in a cycle of the unit period TP(k) including charging periods from a control period TT2 to a control period TT4, and when the information on the number of times of charging indicates required number of times of charging, the coupling state designation circuit 310 executes the first charging operation by bringing the switch Wf into an ON state in each of the charging periods of the required number of times of charging which are included in the unit period TP(k) of the required number of times of charging.

According to Additional Note 4, since the number of times of repetition of the unit period TP(k) in which the first charging operation is executed is stored, the process can be simplified as compared with an aspect of determining termination of the first charging operation each time.

### Additional Note 5

According to Additional Note 5, the ink jet printer 1 according to any one of Additional Notes 1 to 4 further includes a determination unit 6 that determines whether or not to terminate the first charging operation based on the detection potential signal SL, in which the drive signal Com is a signal having a waveform PS repeated in a cycle of the unit period TP(k), and the determination unit 6 determines to terminate the first charging operation when a fluctuation amount of a potential indicated by the detection potential signal SL in the unit period TP(k) is equal to or less than a predetermined amount.

According to the above-described Additional Note 5, since the first charging operation is terminated after the fluctuation of the potential of the detection potential signal SL in the unit period TP(k) is sufficiently reduced, the overcharging or insufficient charging of the parasitic capacitance CPs[m] can be suppressed.

### Additional Note 6

According to Additional Note 6, in the ink jet printer 1 according to any one of Additional Notes 1 to 5, when a first condition that the detection potential signal SL maintains a potential equal to or lower than a first threshold value in the unit period TP(k) and a second condition that the detection potential signal SL maintains a potential equal to or higher than a second threshold value smaller than the first threshold value in the unit period TP(k) are satisfied, the determination unit 6 determines to terminate the first charging operation.

According to Additional Note 6, since the first charging operation is terminated after the fluctuation of the potential of the detection potential signal SL in the unit period TP(k) becomes sufficiently small, the overcharging or insufficient charging of the parasitic capacitance CPs[m] can be suppressed.

What is claimed is:

1. A liquid ejection apparatus comprising:
an ejection portion that includes a piezoelectric element driven by a drive signal supplied to a drive electrode via a first wiring and ejects a liquid in correspondence with the drive of the piezoelectric element; a detection portion that detects a potential of the drive electrode via a second wiring;
an inspection portion that inspects the ejection portion based on a detection result of the detection portion;
a first switch that switches whether or not to electrically couple the first wiring and the drive electrode;
a second switch that switches whether or not to electrically couple the second wiring and the drive electrode;
a third switch that switches whether or not to electrically couple the first wiring and the second wiring; and
a designation portion that designates an electrical coupling state of the third switch, wherein
the designation portion
executes a first charging operation in which the third switch enters an ON state in at least one period of a preparation period before inspection of the ejection portion by the inspection portion, and
terminates the first charging operation when a potential signal corresponding to a potential detected by the detection portion satisfies a specific condition, and continues the first charging operation when the potential signal does not satisfy the specific condition.

2. The liquid ejection apparatus according to claim 1, further comprising:
a resistive element provided between the third switch and the second wiring or between the first wiring and the third switch.

3. The liquid ejection apparatus according to claim 2, wherein
the designation portion
designates an electrical coupling state of the first switch and the second switch, and
executes a second charging operation in which the first switch, the second switch, and the third switch enter an ON state in at least a part of a period after termination of the first charging operation in the preparation period when the potential signal satisfies the specific condition.

4. The liquid ejection apparatus according to claim 1, further comprising:
a storage device that stores information on the number of times of charging, wherein
the drive signal is a signal having a waveform that is repeated in a cycle of a unit period including a charging period, and
when the information on the number of times of charging indicates a first number of times, the designation portion executes the first charging operation by bringing the third switch into an ON state in each of charging periods of the first number of times which are included in the unit period of the first number of times.

5. The liquid ejection apparatus according to claim 1, further comprising:
a determination portion that determines whether or not to terminate the first charging operation based on the potential signal, wherein
the drive signal is a signal having a waveform repeated in a cycle of a unit period, and
the determination portion determines to terminate the first charging operation when a fluctuation amount of a potential indicated by the potential signal in the unit period is equal to or less than a predetermined amount.

6. The liquid ejection apparatus according to claim 5, wherein
when a first condition that the potential signal maintains a potential equal to or lower than a first threshold value in the unit period and a second condition that the potential signal maintains a potential equal to or higher than a second threshold value smaller than the first threshold value in the unit period are satisfied, the determination portion determines to terminate the first charging operation.

7. A head unit comprising:
an ejection portion that includes a piezoelectric element driven by a drive signal supplied to a drive electrode via a first wiring and ejects a liquid in correspondence with the drive of the piezoelectric element;
a detection portion that detects a potential of the drive electrode via a second wiring, and supplies a result signal indicating a detection result to an inspection portion that inspects the ejection portion based on the result signal;
a first switch that switches whether or not to electrically couple the first wiring and the drive electrode;
a second switch that switches whether or not to electrically couple the second wiring and the drive electrode;
a third switch that switches whether or not to electrically couple the first wiring and the second wiring; and
a designation portion that designates an electrical coupling state of the third switch, wherein
the designation portion
executes a first charging operation in which the third switch enters an ON state in at least one period of a preparation period before inspection of the ejection portion by the inspection portion, and
terminates the first charging operation when a potential signal corresponding to a potential detected by the detection portion satisfies a specific condition, and continues the first charging operation when the potential signal does not satisfy the specific condition.

8. The head unit according to claim 7, further comprising:
a resistive element provided between the third switch and the second wiring or between the first wiring and the third switch.

9. The head unit according to claim 8, wherein
the designation portion
designates an electrical coupling state of the first switch and the second switch, and
executes a second charging operation in which the first switch, the second switch, and the third switch enter an ON state in at least a part of a period after termination of the first charging operation in the preparation period when the potential signal satisfies the specific condition.

10. The head unit according to claim 7, wherein
the drive signal is a signal having a waveform that is repeated in a cycle of a unit period including a charging period, and
when information on the number of times of charging stored in a storage device indicates a first number of times, the designation portion executes the first charging operation by bringing the third switch into an ON state in each of charging periods of the first number of times which are included in the unit period of the first number of times.

11. The head unit according to claim 7, wherein
the detection portion supplies the potential signal to a determination portion that determines whether or not to terminate the first charging operation based on the potential signal,
the drive signal is a signal having a waveform repeated in a cycle of a unit period, and
when a fluctuation amount of a potential indicated by the potential signal in the unit period is equal to or less than a predetermined amount, the determination portion determines to terminate the first charging operation.

12. The head unit according to claim 11, wherein
when a first condition in which the potential signal maintains a potential equal to or lower than a first threshold value in the unit period and a second condition in which the potential signal maintains a potential equal to or higher than a second threshold value larger than the first threshold value in the unit period are satisfied, the determination portion determines to terminate the first charging operation.

13. An inspection method of a liquid ejection apparatus including an ejection portion that includes a piezoelectric element driven by a drive signal supplied to a drive electrode via a first wiring and ejects a liquid in correspondence with the drive of the piezoelectric element, a detection portion that detects a potential of the drive electrode via a second wiring, an inspection portion that inspects the ejection portion based on a detection result of the detection portion, a first switch that switches whether or not to electrically couple the first wiring and the drive electrode, a second switch that switches whether or not to electrically couple the second wiring and the drive electrode, and a third switch that switches whether or not to electrically couple the first wiring and the second wiring, the method comprising:
executing a first charging operation in which the third switch enters an ON state in at least one period of a preparation period before inspection of the ejection portion by the inspection portion; and
terminating the first charging operation when a potential signal corresponding to a potential detected by the detection portion satisfies a specific condition, and continuing the first charging operation when the potential signal does not satisfy the specific condition.

14. The inspection method according to claim 13, wherein
the liquid ejection apparatus further includes a resistive element provided between the third switch and the second wiring or between the first wiring and the third switch.

15. The inspection method according to claim 14, wherein
when the potential signal satisfies the specific condition, in the preparation period, a second charging operation in which the first switch, the second switch, and the third switch enter an ON state is executed in at least a part of a period after termination of the first charging operation in the preparation period.

16. The inspection method according to claim 13, wherein
the drive signal is a signal having a waveform that is repeated in a cycle of a unit period including a charging period, and
when information on the number of times of charging stored in a storage device indicates a first number of times, the first charging operation is executed by bringing the third switch into an ON state in each of charging periods of the first number of times which are included in the unit period of the first number of times.

17. The inspection method according to claim 13, wherein
the drive signal is a signal having a waveform repeated in a cycle of a unit period, and
when a fluctuation amount of a potential indicated by the potential signal in the unit period is equal to or less than a predetermined amount, a determination is made to terminate the first charging operation.

18. The inspection method according to claim 17, wherein
when a first condition that the potential signal maintains a potential equal to or lower than a first threshold value in the unit period, and a second condition that the potential signal maintains a potential equal to or higher than a second threshold value larger than the first threshold value in the unit period are satisfied, a determination is made to terminate the first charging operation.
